(19) United States
(12) Patent Application Publication
(10) Pub. No.: US 2011/0173924 A1
(43) Pub. Date: Jul. 21, 2011

(54) Energy Absorptive/Moisture Resistive Underlayment Formed Using Recycled Materials and a Hard Flooring System Incorporating the Same

(75) Inventors: Robert L. Ambrose, JR., Woodridge, IL (US); Martin Lovato, Cape Coral, FL (US); Norman Manning, Hendersonville, TN (US)

(73) Assignee: L&P PROPERTY MANAGEMENT COMPANY, South Gate, CA (US)

(21) Appl. No.: 13/038,096

(22) Filed: Mar. 1, 2011

Related U.S. Application Data
(63) Continuation of application No. 11/461,723, filed on Aug. 1, 2006.
Application No. 11/461,723 is a continuation-in-part of application No. 11/291,633, filed on Dec. 1, 2005, now abandoned.
(60) Provisional application No. 60/632,315, filed on Dec. 1, 2004.

(51) Int. Cl. E04B 1/66; E04B 5/00; B32B 37/02

(52) U.S. Cl. 52/741.4; 156/71

(57) ABSTRACT

A recycled energy absorptive/moisture resistive underlayment includes a recycled energy absorbing layer comprised of either a nonwoven fiber batt formed from shoddy fibers or a foam pad formed from bonded foam. To protect the recycled energy absorbing layer from moisture, a moisture barrier is laminated on either one or preferably both side surfaces of the recycled energy absorbing layer. The moisture barrier laminated on a lower side surface of the recycled energy absorbing layer has a projecting flap which projects from first and second edge surfaces of the recycled energy absorbing layer to which the moisture barrier is laminated to the lower side surface thereof. The projecting flap enhances protection of the recycled energy absorbing layer from moisture by preventing moisture from migrating through seams and/or other exposed portions of the recycled energy absorbing layer.

### CROSS-REFERENCE TO RELATED APPLICATIONS

This application is a Continuation of and claims benefit under 35 USC §120 to co-pending U.S. patent application Ser. No. 11/461,723 entitled “Energy Absorptive/Moisture Resistive Underlayment Formed Using Recycled Materials and a Hard Flooring System Incorporating the Same” filed Aug. 1, 2006, which was a Continuation-In-Part (C-I-P) of and claims benefit under 35 U.S.C. §120 to U.S. patent application Ser. No. 11/291,633 filed Dec. 1, 2005, which, in turn, was related to and claims benefit under 35 U.S.C. §119(e) from U.S. Provisional Patent Application Ser. No. 60/632,315 filed Dec. 1, 2004, all of which are assigned to the Assignee of the present application and hereby incorporated by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure relates to recycled underlayments suitable for use with hard flooring and, more particularly, to an energy absorptive/moisture resistive underlayment formed using recycled materials and suitable for incorporation into a hard flooring system.

### BACKGROUND

A subfloor is either a slab of concrete or one or more sheets of plywood supported by a combination of joists, beams, posts and, in multiple-story buildings, bearing walls while a flooring system encompasses all of the various materials, layers and the like which are installed above the subfloor. In one sense, a flooring system is comprised of a flooring and an underlayment located between the subfloor and the flooring. Most flooring used in structures may be characterized as either a “soft” flooring or a “hard” flooring. For example, carpeting is a common soft flooring while wood is an equally common hard flooring. As its name suggests, soft flooring is typically soft to the touch, quiet underfoot and tends to yield upon application of a force thereto. Conversely, hard flooring tends to be hard to the touch and, as a result, is durable and easy to maintain. However, hard flooring also tends to be relatively noisy, cold, and hard underfoot.

Most hard flooring systems, particularly those which include wood and/or laminate flooring, include an underlayment which serves as a moisture barrier, an energy absorber and a leveler for the hard flooring. When used in a hard flooring system, the moisture barrier will prevent the migration of moisture from the subfloor into the hard flooring. As a result, whether or not an underlayment is capable of functioning as a moisture barrier is often an important consideration when selecting an underlayment for use with a hard flooring system. This is particularly true if the hard flooring system is to cover a concrete subfloor as moisture frequently seeps through the concrete subfloor and, in the absence of a moisture barrier, into the wood or laminate flooring where it causes the wood flooring to warp or the laminate flooring to delaminate. Likewise, energy absorption is often an important consideration when selecting an underlayment for use with a hard flooring system because such an underlayment would absorb some of the sound or “echo” created by a person walking on the hard flooring. As a result, the hard flooring would be quieter and, therefore, more appealing to those concerned with the noise typically generated by hard flooring. Finally, by smoothing high points (peaks), low points (valleys), and other irregularities in a subfloor, an underlayment can help ensure that the relatively inflexible hard flooring rests on a more level surface.

A wide variety of underlayments are used in conjunction with hard flooring. For example, a thin, continuous film of a polymeric material, for example, polyethylene or vinyl, may be installed over the subfloor to provide a moisture barrier for the hard flooring. Oftentimes, a polymeric open cell foam layer is positioned over the polymer film to provide a degree of cushioning to the hard flooring placed above it. Variously, the polymer film and open cell foam layer may be laminated to one another or may be discrete components installed one over the other. Alternatively, a solid sheet of polymer having some cushioning characteristics, for example, a slightly polymerized vinyl chloride polymer, can function as both a moisture barrier and a cushion between the subfloor and the hard flooring. Another suitable underlayment is a laminate composite formed of a moisture impervious vinyl, polyethylene, or polyester film attached to latex or vinyl foam. Other underlayments used with hard flooring include nonwoven fiber batts of polyester, nylon, or polypropylene with a moisture barrier attached to one side of the fiber batt.

One of the goals of all flooring manufacturers is to reduce the time and complexity of installing the flooring. While this goal is important for those types of flooring, for example, carpeting, installed by professional installers, it is a particularly important consideration for those floorings, for example, a laminate or other type of hard flooring, to be installed by consumers as consumers will often base their purchase decisions on the complexity of the installation process, the length of time required to install the hard flooring and/or the price of the hard flooring. These consumer needs have led to an increase in the number of hard flooring systems that have tongue-and-groove, click-together, or other connection mechanisms on a plurality of their edges so that the hard flooring is quick and easy to install. However, with all of these advances in hard flooring installation, the consumer is still required to install an underlayment in the conventional manner, which often includes laying down sheets of the underlayment on the subfloor prior to installing the hard flooring. Therefore, a need exists for a method of simplifying the process of installing an underlayment for hard floorings while simultaneously reducing the time required to install the underlayment.

One of the ongoing concerns of many underlayment manufacturers is the need to reduce manufacturing costs. Lowered manufacturing costs result in lower product costs, which, in turn, make the final product more appealing to the consumers. Underlayment consumers, particularly large retail outlets and flooring installers, are constantly seeking the lowest price on flooring underlayment and frequently change suppliers in order to save a few cents per square foot of underlayment. Thus, it is in the manufacturers' best interest to produce flooring underlayment for the lowest possible price. As the cost of upgrading manufacturing equipment to improve efficiency can be prohibitive, most manufacturers seek to lower production costs by using less expensive materials to manufacture the underlayment. Consequently, what is needed is a flooring underlayment material that is less expensive than the existing flooring underlayment material, thereby allowing manufacturers to produce and sell a flooring underlayment that is less expensive than existing flooring underlayment.

Another ongoing concern for many manufacturers is the consumer's perception of the manufacturer. Manufacturers who use recycled materials to manufacture their product are perceived as environmentally friendly or “green”, a trait preferred by consumers who are environmentally conscious. Consumers who are environmentally conscious are willing to pay a premium for goods that contain recycled materials. Even those environmentally conscious consumers who are unwilling to pay a premium for goods that contain recycled materials will, if given the opportunity of selecting between two otherwise equal products, be more likely to select the product containing recycled materials. Typically, recycled products are partially or entirely made from previously used or waste materials, if the cost of processing the previously used or waste material to render it suitable for reuse is less than the cost of purchasing new material, a recycled product can be less expensive than a product wholly made from new materials. Because recycled materials are both cost-effective and consumer-preferable, a need exists for a flooring underlayment that utilizes recycled materials.

### SUMMARY

In one embodiment, disclosed herein is a flooring underlayment configured for installation between hard flooring and a subfloor. The flooring underlayment is comprised of an energy absorbing layer formed from a recycled material and a first moisture barrier affixed to a first side surface of said energy absorbing layer. When mechanical energy is applied to the hard flooring, the energy absorbing layer absorbs at least a portion of the acoustic energy produced by the hard flooring. In various aspects thereof, the energy absorbing layer is a nonwoven fiber batt formed of recycled material, a nonwoven fiber batt formed from shoddy fiber, a foam pad formed from recycled material or a foam pad formed from bonded foam.

In further aspects thereof, the first moisture barrier may be a moisture impermeable film laminated to the first side surface of the energy absorbing layer or a closed cell foam attached to the first side surface of the energy absorbing layer. In still further aspects thereof, the flooring underlayment may further include a second moisture barrier laminated onto a second side surface of the energy absorbing layer. In this aspect, the first moisture barrier engages the subfloor while the second moisture barrier engages the hard flooring. As before, in various further aspects thereof, the energy absorbing layer may be a nonwoven fiber batt formed from shoddy fibers or a foam pad formed from bonded foam. In the alternative, the first and/or second moisture barriers may instead be formed of a closed cell foam.

In another embodiment, a flooring underlayment configured for installation between hard flooring and a subfloor is disclosed. The flooring underlayment is comprised of an energy absorbing layer formed from a recycled material, a first moisture barrier for engaging a subfloor and a second moisture barrier for engaging hard flooring. The energy absorbing layer includes first side surface, a second side surface and a plurality of edge surfaces. The first moisture barrier is laminated to the first side surface of the energy absorbing layer and includes at least one edge surface laying flush with a corresponding one of the edge surfaces of the energy absorbing layer and at least one edge surface projecting past a corresponding one of the edge surfaces of the energy absorbing layer. The second moisture barrier is laminated to the second side surface of the energy absorbing layer and includes plural edge surfaces, each of which corresponds to and lays flush with one of the edge surfaces of the energy absorbing layer. When mechanical energy is applied to the hard flooring, the energy absorbing layer absorbs at least a portion of the acoustic energy produced by the hard flooring. In various aspects thereof, the energy absorbing layer is a nonwoven fiber batt formed from shoddy fiber or a foam pad formed from bonded foam.

In still another embodiment, disclosed herein is a hard flooring system configured for installation in a space defined by a subfloor, a first wall and a second wall. The hard flooring system is comprise of a first energy absorptive/moisture resistive underlayment section, a second energy absorptive/moisture resistive underlayment section, a hard flooring and a moisture resistive section. In turn, each of the first and second energy absorptive/moisture resistive underlayment sections is comprised of an energy absorbing layer formed from a recycled material, a first moisture barrier for engaging a subfloor and a second moisture barrier engaging the hard flooring. The first moisture barrier is laminated to a first side surface of the energy absorbing layer and includes at least one edge surface laying flush with a corresponding one of the edge surfaces of the energy absorbing layer and at least one edge surface projecting past a corresponding one of the edge surfaces of the energy absorbing layer. The second moisture barrier is laminated to a second side surface of the energy absorbing layer and includes plural edge surfaces, each of which lays flush with one of the plurality of edge surfaces of the energy absorbing layer.

As further disclosed herein, the projecting edge surface of the first moisture barrier laminated to the energy absorbing layer of the first energy absorptive/moisture resistive underlayment section engages a portion of the first wall while the projecting edge surface of the first moisture barrier laminated to the energy absorbing layer of the second energy absorptive/moisture resistive underlayment is positioned underneath a portion of the first moisture barrier laminated to the energy absorbing layer of the first energy absorptive/moisture resistive underlayment section. Finally, the moisture resistive section engages the second wall and an edge surface of the energy absorbing layer of the second energy absorptive/moisture resistive underlayment section which abuts the second wall.

In one aspect thereof, the moisture resistive section extends underneath a portion of the first moisture barrier laminated to the energy absorbing layer of the second energy absorptive/moisture resistive underlayment section. In others, the energy absorbing layer is a nonwoven fiber batt formed from shoddy fiber or a foam pad formed from bonded foam.

### BRIEF DESCRIPTION OF THE DRAWINGS

For a more complete understanding of the present invention, and for further details and advantages thereof, reference is now made to the accompanying drawings, in which:

FIG. 1 is a perspective view of an energy absorptive/moisture resistive underlayment formed using recycled materials;

FIG. 2A is a perspective view of a hard flooring system which incorporates an energy absorptive/moisture resistive underlayment formed using recycled materials;

FIG. 2B is a partially cut-away, cross-sectional view of the energy absorptive/moisture resistive underlayment of FIG. 2A;

FIG. 3 is a perspective view of an alternate embodiment of the energy absorptive/moisture resistive underlayment of FIG. 1 or FIG. 2;

FIG. 4 is a block diagram of a first method of manufacturing an energy absorptive/moisture resistive underlayment using recycled materials;

FIG. 5 is a plan view of an apparatus for manufacturing an energy absorptive/moisture resistive underlayment in accordance with the method of FIG. 4;

FIG. 6A is a side view of a first thermal bonding apparatus suitable for use in manufacturing a recycled energy absorptive/moisture resistive underlayment in accordance with the method of FIG. 4;

FIG. 6B is a side view of a second, alternative, thermal bonding apparatus suitable for use in manufacturing a recycled energy absorptive/moisture resistive underlayment in accordance with the method of FIG. 4;

FIG. 7 is a block diagram of a second method of manufacturing an energy absorptive/moisture resistive underlayment using recycled materials;

FIG. 8 is a side view of a mixing tank suitable for use in manufacturing a recycled energy absorptive/moisture resistive underlayment in accordance with the method of FIG. 7;

FIG. 9 is a side view of an apparatus for forming bonded foam suitable for use in manufacturing a recycled energy absorptive/moisture resistive underlayment in accordance with the method of FIG. 7;

FIG. 10 is a side view of an apparatus for forming sheets of bonded foam suitable for use in manufacturing a recycled energy absorptive/moisture resistive underlayment in accordance with the method of FIG. 7;

FIG. 11 is a side view of a second, alternative, apparatus for forming bonded foam suitable for use in manufacturing a recycled energy absorptive/moisture resistive underlayment in accordance with the method of FIG. 7;

FIG. 12 is a side view of an apparatus for laminating a moisture resistive film onto an energy absorbing layer suitable for use in manufacturing a recycled energy absorptive/moisture resistive underlayment in accordance with the method of FIG. 4 or the method of FIG. 7; and

FIG. 13 is a side view of an apparatus for laminating a moisture resistive closed cell foam onto an energy absorbing layer suitable for use in manufacturing a recycled energy absorptive/moisture resistive underlayment in accordance with the method of FIG. 4 or the method of FIG. 7.

### DETAILED DESCRIPTION

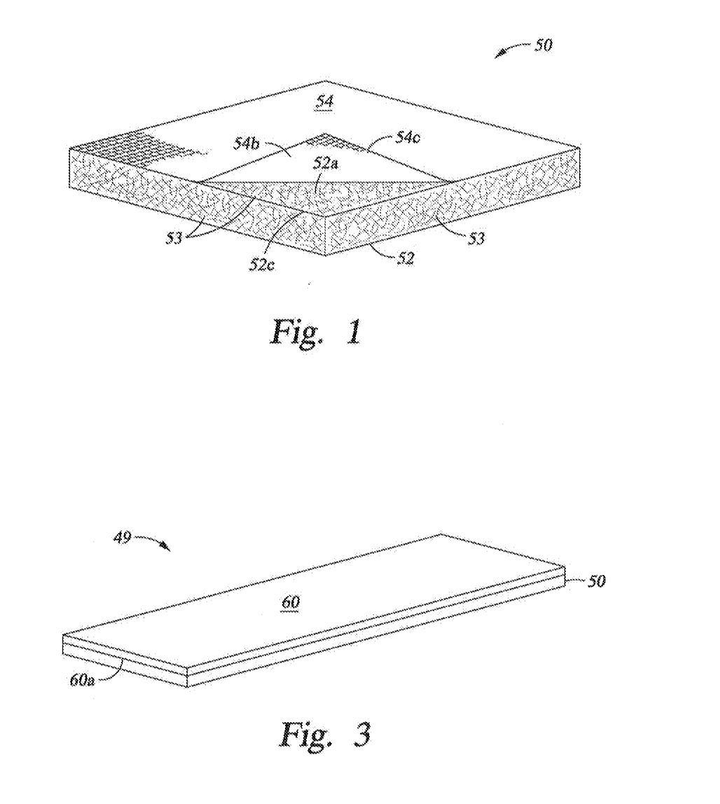

A recycled energy absorptive/moisture resistive underlayment 50 will now be described in detail. As used herein the term “recycled energy absorptive/moisture resistive underlayment” shall refer to an energy absorptive/moisture resistive underlayment formed using one or more recycled materials as a component thereof. Thus, by definition, the recycled energy absorptive/moisture resistive underlayment 50 is formed using one or more recycled materials. As best seen in FIG. 1, the recycled, energy absorptive/moisture resistive underlayment 50 is comprised of a moisture barrier 54 bonded to an energy absorbing layer 52, for example, by laminating side surface 54b of the moisture barrier 54 onto side surface 52a of the energy absorbing layer 52. Of course, in FIG. 1, the moisture barrier 54 has been partially pulled away to better show the side surfaces 52a and 54b of the energy absorbing layer 52 and the moisture barrier 54, respectively.

Uniquely, the energy absorbing layer 52 illustrated in FIG. 1 is formed from a selected type of recycled materials. Thus, in accordance with the nomenclature set forth hereinabove, the energy absorbing layer 52 may properly be referred to as recycled energy absorbing layer 52. In the embodiment illustrated in FIG. 1, the recycled energy absorbing layer 52 is a nonwoven fiber batt formed from shoddy fibers 53 bonded together in a manner to be more fully described below. In an alternate embodiment not shown in FIG. 1, the recycled energy absorbing layer 52 is a foam pad formed from recycled foam, which is commonly known in the art as bonded foam.

Unfortunately, in the past, the term “shoddy” has been used somewhat inconsistently. Accordingly, for purposes of the foregoing disclosure, the term “shoddy material” shall refer to material that has been collected so that the fibers forming the shoddy material may be reused. The term “shoddy fibers” shall refer to recycled fibers, including both loose waste fibers and fibers that have been reclaimed from shoddy material. Finally, the term “shoddy products” shall refer to products formed using shoddy fibers. For example, if bedding material, for example, a nonwoven fiber batt, is acquired for reuse, the nonwoven fiber batt shall be termed “shoddy material.” The polyester fibers reclaimed from the nonwoven fiber batt for reuse shall be termed “shoddy polyester fibers.” Finally, if a recycled nonwoven fiber batt is constructed from the shoddy polyester fiber, the recycled nonwoven fiber batt may be termed as either a “shoddy nonwoven fiber batt” or a “nonwoven fiber batt formed using shoddy polyester fibers.”

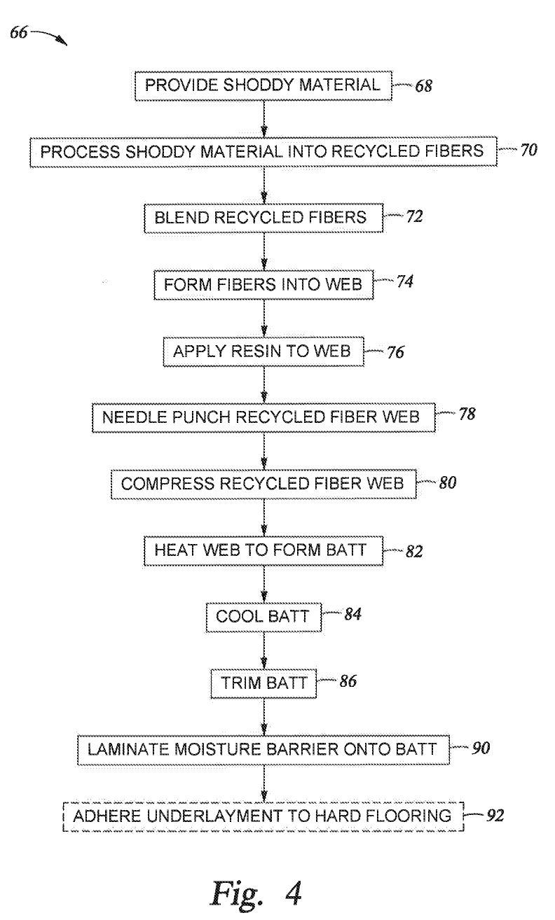

As previously set forth, shoddy fibers comprise fibers that were previously used in clothing, bedding, fabric and other natural and synthetic materials, which have been collected for purposes of recycling the fibers thereof. Because recycled fibers originate from multiple sources, shoddy fibers are often a blend of a variety of types of fibers. Alternatively, the recycled fibers may be collected from a single fiber source. If so, the shoddy fiber would be comprised of a specific type of fiber. In one example, the recycled fibers may be comprised of the fibers which tend to accumulate as an unwanted by-product of a manufacturing process, e.g., when some of the polyester fibers consumed during the manufacture of nonwoven fiber batts for use in bedding products are wasted, for example, when untangling a newly formed nonwoven fiber web or trimming edges of a newly formed nonwoven fiber batt. Similarly, some cotton fibers are wasted during yarn spinning processes. In another example, consumer products formed from a single type of fiber, for example, the 100% polyester fiber batts used in some bedding materials, may be collected for recycling. Whether comprised of a single fiber type or plural fiber types, shoddy material is generally cleaned and shredded to form a homogeneous blend of fibers prior to being formed into a shoddy nonwoven fiber batt suitable for use as the recycled energy absorbing layer 52. Further details of the process by which a nonwoven fiber batt suitable for use as the recycled energy absorbing layer 52 is formed will be described later with respect to FIGS. 4, 5, 6A and 6B.

When a foam pad is employed as the recycled energy absorbing layer 52, the foam pad is typically formed from bonded foam-foam comprised of a plurality of recycled foam pieces bonded to one another. The recycled foam pieces may be acquired from a variety of sources, including manufacturing processes in which foam is wasted during the formation of prime or bond foam pads, for example, while trimming edges of newly formed prime foam or bond foam pads. Used carpet pads that have been collected for recycling purposes are another source of the recycled foam pieces used to form the bonded foam pads. The foam pieces are preferably polyurethane foam, but may also be other materials such as latex foam, polyvinyl chloride (PVC) foam, or any other polymeric foam.

The moisture barrier 54 is a thin layer of material that is attached or otherwise laminated onto the recycled energy absorbing layer 52. As its name implies, the moisture barrier 54 is formed from a material that is impervious to liquid moisture and moisture vapor. Alternatively, the moisture barrier 54 may be permeable with respect to moisture vapor, but impervious to liquid moisture. Such moisture barriers 54 are advantageous because they discourage the transmission of liquid moisture across the energy absorptive/moisture resistive underlayment 50 yet allow the energy absorptive/moisture resistive underlayment 50 to “breathe.” in the alternative, the moisture barrier 54 may be configured such that it includes a hydrophobic side and a hydrophilic side. If so, the moisture barrier 54 would encourage the migration of moisture in one direction but not in the opposite direction.

The moisture barrier 54 is typically a polymeric film, such as polyethylene or ethylene vinyl acetate (EVA) copolymer. An example of a suitable film is 150 gauge low density polyethylene film weighing 35 grams per square meter, available from numerous manufacturers including The Dow Chemical Company of Midland, Mich. and E.I. du Pont de Nemours and Company of Wilmington, Del. Alternatively, the moisture barrier 54 may be a layer of closed cell foam, such as a styrene butadiene rubber (SBR), latex, or PVC foam. By definition, closed cell foam has too few interconnecting cells to allow the transmission of bulk fluids through the foam. The formulation of a typical closed cell foam is disclosed in U.S. patent application Ser. No. 10/306,271 filed Nov. 27, 2002 to Brodeur et al., entitled “Moisture Barrier and Energy Absorbing Cushion,” assigned to the Assignee of the present application and hereby incorporated by reference as if reproduced in its entirety. A number of other moisture barriers 54 are commercially available, any one of which may be suitable for use with the recycled energy absorptive/moisture resistive underlayment 50.

While the recycled energy absorptive/moisture resistive underlayment 50 is described in conjunction with a hard flooring system, it is fully contemplated that the recycled energy absorptive/moisture resistive underlayment 50 can be used as an underlayment for any type of flooring system. As used herein, the term “flooring system” refers to any type of flooring used in combination with an underlayment. The term “flooring” includes both soft flooring and hard flooring. As used herein, the term “soft flooring” refers to non-rigid flooring products such as carpets and rugs while the term “hard flooring” refers to rigid flooring products such as ceramic tile, linoleum, vinyl, wood flooring, and laminate flooring. Hard floorings typically require an underlayment with a moisture barrier that keeps moisture from migrating from the subfloor into the hard flooring layer. Moisture in the hard flooring is not preferred because the moisture tends to warp, rot, or delaminate the hard flooring. As used herein, the term “laminate flooring” describes any flooring product that contains various layers attached or otherwise laminated together and includes laminated pressboard, paper, wood particles, and the like. The term “laminate flooring” also includes ceramic tile or other flooring attached to laminated pressboard, paper, or wood particles, and the like. Examples of laminate flooring are the products sold under the names PERGO® by Pergo AB of Stockholm, Sweden laminate flooring and EDGE GTL™ by Edge Flooring of Dalton, Ga.

It is further contemplated that the orientation of the recycled energy absorptive/moisture resistive underlayment 50 relative to the subfloor and flooring may be varied. For example, the recycled energy absorptive/moisture resistive underlayment 50 may be oriented such that the moisture barrier 54 is positioned above the energy absorbing layer 52 and adjacent the hard flooring or oriented such that the moisture barrier layer 54 is positioned below the energy absorbing layer 52 and adjacent the subfloor. It should be readily appreciated that the recycled energy absorptive/moisture resistive underlayment illustrated in FIG. 1 may be used in either of the aforementioned orientations. Typically, the orientation of the recycled energy absorptive/moisture resistive underlayment 50 is determined during the installation or the hard flooring system. For example, if the recycled energy absorptive/moisture resistive underlayment 50 is oriented such that the moisture barrier 54 faces the subfloor, the moisture barrier 54 will prevent the migration of moisture from the subfloor into the energy absorbing layer 52 and the hard flooring. Such an orientation is particularly well suited for the installation of hard flooring systems in basements and onto slab foundations directly. Alternatively, if the recycled energy absorptive/moisture resistive underlayment 50 is placed such that moisture barrier 54 faces the hard flooring, the moisture barrier 54 prevents the migration of moisture from the hard flooring into the recycled energy absorbing layer 52. Such an orientation is particularly well suited for the installation of hard flooring systems in upper floors. It should be clearly understood, however, that the orientation of the moisture barrier 54 relative to the recycled energy absorbing layer 52 within any particular recycled energy absorptive/moisture resistive underlayment 50 and associated hard flooring system may vary from the foregoing based upon any number of considerations unique to that particular hard flooring system.

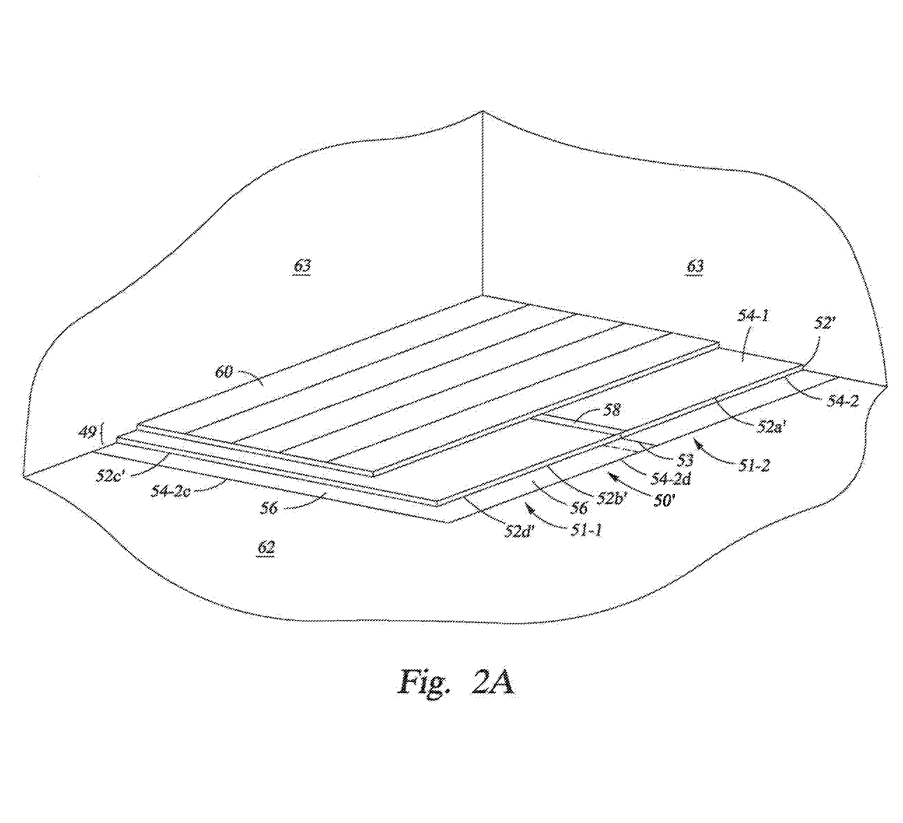

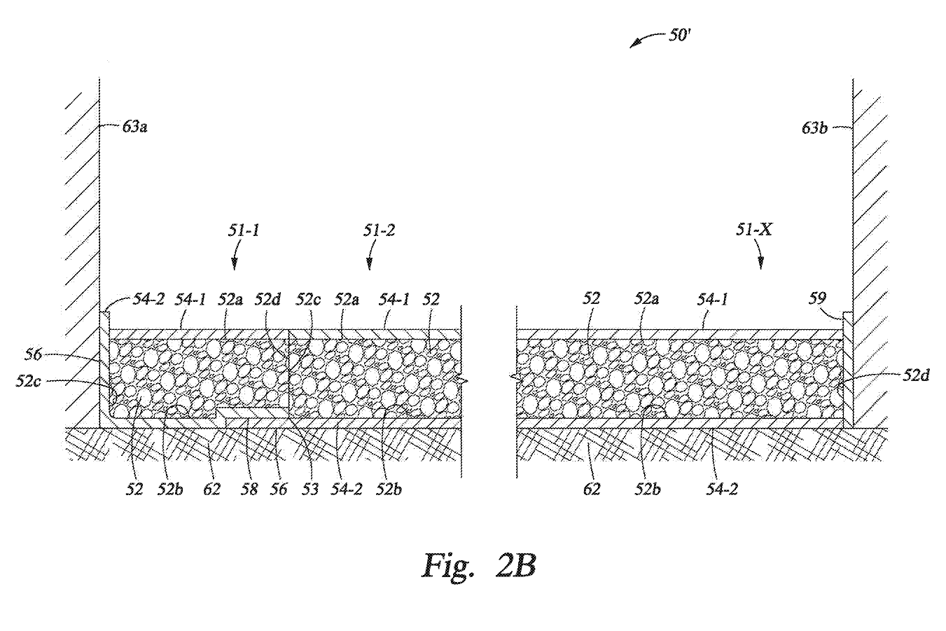

Rather than the recycled energy absorptive/moisture resistive underlayment 50 having a moisture barrier 54 laminated on one side of the recycled energy absorbing layer 52, as illustrated in FIG. 1, it is contemplated that another embodiment of a recycled energy absorptive/moisture resistive underlayment may instead be configured such that a moisture barrier is laminated on both sides of the recycled energy absorbing layer. Such an alternate configuration for a recycled energy absorptive/moisture resistive underlayment is illustrated in FIGS. 2A-B. As may now be seen, a recycled energy absorptive/moisture resistive underlayment 50′ is comprised of a recycled energy absorbing layer 52′ having a first moisture barrier 54-1 laminated onto a first side surface 52a′ of the recycled energy absorbing layer 52′ and a second moisture barrier 54-2 Laminated onto a second side surface 52b′ of the recycled energy absorbing layer 52′. As before, the recycled energy absorbing layer 52′ is formed from a selected type of recycled materials, typically, either a nonwoven fiber batt formed from shoddy fibers or a foam pad formed from bonded foam. In the embodiment illustrated in FIGS. 2A-B, however, the recycled energy absorbing layer 52 is comprised of a foam pad formed from bonded foam.

By being configured such that moisture barriers are laminated on first and second side surfaces of the recycled energy absorbing layer, it is contemplated that the recycled energy absorptive/moisture resistive underlayment 50′ illustrated in FIGS. 2A-B will enjoy the benefits of both embodiments described hereinabove, specifically, those benefits which result from placement of the moisture barrier between the subfloor and the recycled energy absorbing layer and those benefits which result from placement of the moisture barrier between the recycled energy absorbing layer and the hard flooring. It is contemplated that the alternate configuration illustrated in FIGS. 2A-B is particularly desirable when the recycled energy absorbing layer 52′ contains greater amounts of absorbent materials as such materials tend to more readily absorb moisture into the recycled energy absorbing layer 52′, thereby promoting the growth of mildew, mold, fungus, and/or microbes. Accordingly, it is further contemplated that the recycled energy absorptive/moisture resistive underlayment 50′ may also contain an antimicrobial additive to discourage the growth of mildew, mold, fungus, and microbes, particularly when the recycled energy absorbing layer 52′ is formed using greater amounts of absorbent materials. Two examples of an antimicrobial, antifungal, or similar additives suitable for the purposes contemplated herein are the Sanitized™ and Actigard™ product lines available from Sanitized AG of Burgdorf, Switzerland or other antimicrobial product line suitable for use in bonded foam products. The incorporation of an antimicrobial, antifungal, or similar additive to an underlayment is described in U.S. patent application Ser. No. 10/840,309 filed May 6, 2004, entitled “Anti-Microbial Carpet Underlay and Method of Making”, assigned to the Assignee of the present application and hereby incorporated by reference as if reproduced in its entirety.

in still another alternate embodiment not shown in the drawings, it is further contemplated that the recycled energy absorptive/moisture resistive underlayment can be configured without a moisture barrier laminated onto either of the side surfaces of the recycled energy absorbing layer. It is contemplated that lower production costs for the recycled energy absorptive/moisture resistive underlayment would be achieved if the recycled energy absorbing layer were manufactured without a moisture barrier laminated thereto. In this regard, it is noted that the moisture barrier may be unnecessary for certain applications in which discouraging the migration of moisture is not of particular concern. For example, in dry climates such as the southwest United States, moisture is not as problematic as in coastal and other humid regions of the country. As a result, the need for a moisture barrier is not as great in these areas. In addition, multi-story homes may not require a moisture barrier on the upper floors because the migration of moisture from the subfloor is typically limited to the bottom floor of the residence. Accordingly, the need for a moisture barrier may be less for those underlayments to be installed on upper floors. Consequently, in some applications, it is contemplated that the moisture barrier may be eliminated from the manufacturing process described herein, thereby reducing the production costs of the recycled energy absorptive/moisture resistive underlayment and, in turn, making the recycled energy absorptive/moisture resistive underlayment less expensive and, as a result, more appealing to consumers.

Returning to FIG. 2A, in a still further alternative embodiment, the recycled energy absorptive/moisture resistive underlayment 50 can be configured to still further enhance the moisture resistance thereof. In the embodiment illustrated in FIG. 1, the recycled energy absorptive/moisture resistive underlayment 50 is configured such that the recycled energy absorption layer 52 and the moisture barrier 54 have generally equal surface areas and are aligned on all four edge surfaces thereof. For example, edge surface 52c of the recycled energy absorbing layer 52 is aligned with edge surface 54c of the moisture barrier 54. In the embodiment illustrated in FIG. 2A, however, the second moisture barrier 54-2 is formed to include a projecting side flap 56 that results in edge surfaces 54-2c and 54-2d of the second moisture barrier 54-2 extending past the corresponding edge surfaces 52c′ and 52d′ of the recycled energy absorbing layer 52. Preferably, the projecting side flap 56 is sized such that the edge surface 54-2c of the second moisture barrier 54-2 is about 4 inches beyond the edge surface 52c of the recycled energy absorbing layer 52′ and the edge surface 54-2d of the second moisture barrier 54-2 is about 4 inches beyond the edge surface 52d′ of the recycled energy absorbing layer 52′.

The advantage of configuring the second moisture barrier 54-2 to include the projecting side flap 56 is readily apparent when one considers that an underlayment is rarely, if ever, installed in one section. For example, the recycled energy absorptive/moisture resistive underlayment 50′ illustrated in FIG. 2A is comprised of a first section 51-1 and a second section 51-2, each having an edge surface that abuts the edge surface of the other. By configuring the energy absorptive/moisture resistive underlayment 50′ such that the second moisture barrier 54-2 includes the projecting side flap 56, the second, subsequently installed, section 51-2 of the recycled energy absorptive/moisture resistive underlayment 50′ is positioned, relative to the first, previously installed, section 51-1 of the recycled energy absorptive/moisture resistive underlayment 50′ such that a portion of the second moisture barrier 54-2 of the second section 51-2 extends underneath a portion of the first moisture barrier 54-1 of the first section 51-1, thereby creating an overlapping moisture barrier at seam 53 which separates the first section 51-1 of the recycled energy absorptive/moisture resistive underlayment 50′ from the second section 51-2 of the recycled energy absorptive/moisture resistive underlayment 50′.

It is contemplated that an overlapping moisture barrier is advantageous over a non-overlapping moisture barrier in that the overlapping moisture barrier is better equipped to prevent moisture from circumventing the moisture barrier at the seam separating two sections of underlayment. Thus, the overlapping moisture barrier is additional assurance that the moisture barrier will discourage the migration of moisture from the subfloor to the hard flooring. It is contemplated that, if the moisture barrier is laminated onto a lower side surface of the recycled energy absorbing layer, the weight of the recycled energy absorbing layer will be sufficient to hold the projecting flap in place. If, however, the moisture barrier is laminated onto an upper side surface of the recycled energy absorbing layer, it is contemplated that tape may be used to secure the projecting flap in place. However, regardless as to which moisture barrier includes the projecting flap, it is further contemplated that the subsequently installed section 51-2 of the recycled energy absorptive/moisture resistive underlayment 50 is secured to the previously installed section 51-1 of the recycled energy absorptive/moisture resistive underlayment 50′ using a strip 58 of tape placed over the seam 53 between the first and second sections 51-1 and 51-2 of the recycled energy absorptive/moisture resistive underlayment 50.

Continuing to refer to FIG. 2A, the installation of a flooring system 49 comprised of the recycled energy absorptive/moisture resistive underlayment 50′ and a hard flooring 60 will now be described briefly. FIG. 2A is a perspective view of a corner of a room where the recycled energy absorptive/moisture resistive underlayment 50′ has been installed between a subfloor 62 and the hard flooring 60. As previously set forth, the recycled energy absorptive/moisture resistive underlayment 50′ may be installed with the moisture barrier abutting the hard flooring 60, with the moisture barrier abutting the subfloor 62 or, as illustrated in FIG. 2A, with a first moisture barrier 54-1 abutting the hard flooring 60 and a second moisture barrier 54-2 abutting the subfloor 62. As previously set forth, the recycled energy absorptive/moisture resistive underlayment 50′ is configured such that the second moisture barrier 54-2 includes the projecting flap 56. As indicated by the phantom line appearing in FIG. 2A, the projecting flap 56 of the second moisture barrier 54-2 of the second section 51-2 of the recycled energy absorptive/moisture resistive underlayment 50′ is covered by the second moisture barrier 54-2 of the first section 51-1 of the recycled energy absorptive/moisture resistive underlayment 50.

When installing the second, subsequent, section 51-2 of the recycled energy absorptive/moisture resistive underlayment 50, the installer places the subsequent section 51-2 of the recycled energy absorptive/moisture resistive underlayment 50 directly adjacent to the first, previously installed, section 51-1 of the recycled energy absorptive/moisture resistive underlayment 50′. If the second moisture barrier 54-2 of the subsequently installed section 51-2 includes a projecting flap 56, the previously installed section 51-1 is pulled up so that the projecting flap 56 may be laid on the subfloor 62. The previously installed section 51-1 is then placed such that the second moisture barrier 54-2 of the previously installed section 51-1 covers the projecting flap 56 of the second moisture barrier 54-2 of the subsequently installed section 51-2. The previously and subsequently installed sections 51-1 and 51-2 are then secured in place with the strip 58 of tape. After the recycled energy absorptive/moisture resistive underlayment 50′ has been installed over the subfloor 62, the hard flooring 60 is installed on top of the recycled energy absorptive/moisture resistive underlayment 50′, thereby completing assembly of the hard flooring system 49. Variously, the seams of the hard flooring 60 may run parallel, perpendicular, diagonally, or any other orientation with respect to the seams 53 of the recycled energy absorptive/moisture resistive underlayment 50′.

In an alternative embodiment of the installation process, an additional section of moisture barrier (not shown in FIG. 2A) may be installed under the lower and edge surfaces of the recycled energy absorptive/moisture resistive underlayment 50′ where the subfloor 62 meets the walls 63. By doing so, the additional section of moisture barrier extends underneath the second moisture barrier 54-1 and up along the walls 63 of the room. If the recycled energy absorptive/moisture resistive underlayment 50′ is configured with the projecting flap 56, the projecting flap 56 can be used to extend up along the wall 63 by simply bending the projecting flap 56 so that it engages the wall 63. The additional section of moisture barrier extending up along the walls 63 may be concealed using trim (not shown) after the hard flooring 60 has been installed over the recycled energy absorptive/moisture resistive underlayment 50. By configuring the hard flooring system 49 so that the second moisture barrier extends upward along the walls 63, the hard flooring 60 is protected from moisture migrating from the subfloor 62 along the edge surfaces of the recycled energy absorptive/moisture resistive underlayment 50′

The use of the projecting flaps 56 and/or the additional section of moisture barrier to enhance the protection of the recycled energy absorbing layer from moisture will now be more fully described with respect to FIG. 2B. As may now be seen, the recycled energy absorptive/moisture resistive underlayment 50 has been installed above the subfloor 62 of a room. The recycled energy absorptive/moisture resistive underlayment 50′ is comprised of plural underlayment sections 51-1 through 51-X which enable the recycled energy absorptive/moisture resistive underlayment 50′ to extend from a first wall 63a of the room to a second wall 63b thereof. Each underlayment section 51-1 through 51-X is comprised of a recycled energy absorbing layer 52 formed from bonded foam. The recycled energy absorbing layer 52 has a first side surface 52a on which a first moisture barrier 54-1 has been laminated and a second side surface 52b on which a second moisture barrier 54-2 has been laminated. Each of the second moisture barriers 54-2 includes a projecting flap 56 which extends beyond an edge surface 52c of the recycled energy absorbing layer 52 to which the second moisture barrier 54-2 is laminated. As a result, the projecting flaps 56 may be easily repositioned relative to the recycled energy absorbing layer 52 to which it is attached.

The edge surface 52c of the recycled energy absorbing layer 52 of the first underlayment section 51-1 is positioned to abut the wall 63a. The projecting flap 56 is bent at a 90.degree. angle relative to the subfloor 62 so that it separates the wall 63a from the edge surface 52c of the recycled energy absorbing layer 52 which, absent the projecting flap 56, would engage the wall 63a. As a result, the projecting flap 56 enhances the protection of the recycled energy absorbing layer 52 of the first underlayment section 51-1 from moisture migrating from the subfloor 62 along the wall 63a since, absent the projecting flap 56, the edge surface 52c of the recycled energy absorbing layer 52 would be unprotected by any type of moisture barrier.

The edge surface 52c of the recycled energy absorbing layer 52 of the second underlayment section 51-2 is positioned to abut the edge surface 52d of the recycled energy absorbing layer 52 of the first underlayment section 51-1, thereby forming seam 53 separating the first and second underlayment sections 51-1 and 51-2. Here, however, the projecting flap 56 of the second moisture barrier 54-2 of the second underlayment section 51-2 extends along a portion of the subfloor 62 beyond the edge surface 52c of the second underlayment section 51-2 to which the second moisture barrier 54-2 is laminated. For that portion of the subfloor 62 for which the second moisture barrier 54-2 of the first underlayment section 51-1 and the projecting flap 56 of the second underlayment section 51-2 overlap, the second moisture barrier 54-2 of the first underlayment section 51-1 extends over the projecting flap 56 of the second moisture barrier 54-2 of the second underlayment section 51-2. However, as the projecting flap 56 is relatively thin compared to the first underlayment section 51-1 as a whole, no other displacement of the first underlayment section 51-1 results from the second moisture barrier 54-2 of the first underlayment section 51-1 extending over the projecting flap 56 of the second moisture barrier 54-2 of the second underlayment section 51-2 instead of the subfloor 62. By covering the seam 53 separating the first and second underlayment sections 51-1 and 51-2, the projecting flap 56 of the second underlayment section 51-2 enhances the protection of the recycled energy absorbing layer 52 of both the first and second underlayment sections 51-1 and 51-2 from moisture migrating from the subfloor along the seam 53 between the first and second underlayment sections 51-1 and 51-2.

The edge surface 52d of the recycled energy absorbing layer 52 of the underlayment section 51-X is positioned to abut the wall 63b. As no projecting flap extends from the second moisture barrier 54-2 laminated to recycled energy absorbing layer 52 of the underlayment section 51-X, an additional moisture barrier 59 is inserted between the edge surface 52d of the recycled energy absorbing layer 52 and the wall 63b. The moisture barrier 59 is sized to extend, along the wall 63b, from the subfloor 62 to above the first moisture barrier 54-1 of the underlayment section 51-X and is preferably formed of a moisture resistive material similar to that use to form the first and second moisture barriers 54-1 and 54-2. For ease of handling and installation, however, it is preferred that the moisture barrier 59 be somewhat thicker than the first and second moisture barriers 54-1 and 54-2. The moisture barrier 59 separates the wall 63b from the edge surface 52d of the recycled energy absorbing layer 52 of the underlayment section 51-X. As a result, the moisture barrier 59 enhances the protection of the recycled energy absorbing layer 52 of the underlayment section 51-X from moisture migrating from the subfloor 62 along the wall 63b since, absent the moisture barrier 59, the edge surface 52d of the recycled energy absorbing layer 52 of the underlayment section 51-X would be unprotected by any type of moisture barrier.

In one aspect, it is contemplated that the moisture barrier 59 be configured such that it extends along the wall 63b, bends at a 90.degree. angle at the juncture of the wall 63b and the subfloor 62 and then extend along a portion of the subfloor 62. Such a configuration would further enhance the protection of the recycled energy absorbing layer 52 of the underlayment section 51-X as the seam between the second moisture barrier 54-2 and the moisture barrier 59 would be protected in a manner similar to that protecting the seam 53 between the first and second underlayment sections 51-1 and 51-2. To configure the moisture barrier 59 in this manner, however, the moisture barrier 59 would need to be relatively flexible so that it can bend in the aforedescribed manner at the juncture of the wall 63b and the subfloor 62.

Referring next to FIG. 3, still another alternative embodiment of the hard flooring system 49 may now be seen. In this embodiment, the recycled energy absorptive/moisture resistive underlayment 50 is fixedly secured to a lower side surface 60a of the hard flooring 60. It is contemplated that, in many cases, securing the recycled energy absorptive/moisture resistive underlayment 50 to the lower side surface 60a of the hard flooring 60 is considered advantageous because it combines the installation of the recycled energy absorptive/moisture resistive underlayment 50 onto a subfloor and the installation of the hard flooring 60 onto the recycled energy absorptive/moisture resistive underlayment 50. By utilizing the embodiment illustrated in FIG. 3, the user can install the recycled energy absorptive/moisture resistive underlayment 50 and the hard flooring layer 60 in substantially less time than if the user was required to separately install the energy absorptive/moisture resistive underlayment 50 and the hard flooring layer 60.

As before, the recycled energy absorptive/moisture resistive underlayment 50 is comprised of a recycled energy absorbing layer to which a moisture barrier is laminated to either the lower side surface, the upper side surface, both of the lower and upper side surfaces or to neither the lower nor the upper side surfaces. Again, as before, the recycled energy absorbing layer may be comprised of a nonwoven fiber batt formed from shoddy fibers or a foam pad formed from bonded foam. To enhance the protection of the recycled energy absorbing layer from moisture migrating from the subfloor, it is contemplated that the recycled energy absorptive/moisture resistive underlayment may be configured such that the second moisture barrier laminated to a lower side surface of the recycled energy absorbing layer include one or more projecting flaps similar in design to the projecting flaps described with respect to FIGS. 2A-B. To further enhance the protection of the recycled energy absorbing layer from moisture migrating from the subfloor, it is further contemplated that the hard flooring system 49 may be further configured to include an additional section of moisture resistive material, again, similar to that previously described with respect to FIGS. 2A-B.

Referring next to FIG. 4, a first method 66 for manufacturing the energy absorptive/moisture resistive underlayment 50 will now be described in greater detail. As will be more fully described below, the method 66 is a process in which shoddy material is processed to yield recycled fibers for use in forming a nonwoven fiber batt which serves as the energy absorbing layer 52 of the energy absorptive/moisture resistive underlayment 50. As may now be seen, the method 66 includes providing shoddy material at 68, processing the shoddy material into recycled fibers at 70, blending the recycled fibers at 72, forming a web from the recycled fibers at 74, coating the web with a resin at 76, needle punching the web at 78, compressing the web at 80, heating the web to form a nonwoven fiber batt at 82, cooling the nonwoven fiber batt at 84, trimming the nonwoven fiber batt at 86 and laminating a moisture barrier onto the nonwoven fiber batt at 90 to complete formation of the energy absorptive/moisture resistive underlayment 50. If it is desired to attach the newly formed energy absorptive/moisture resistive underlayment 50 to the hard flooring layer 60 in the manner illustrated in FIG. 3, then the method 66 further comprises laminating or otherwise adhering the energy absorptive/moisture resistive underlayment 50 to the hard flooring 60 at 92.

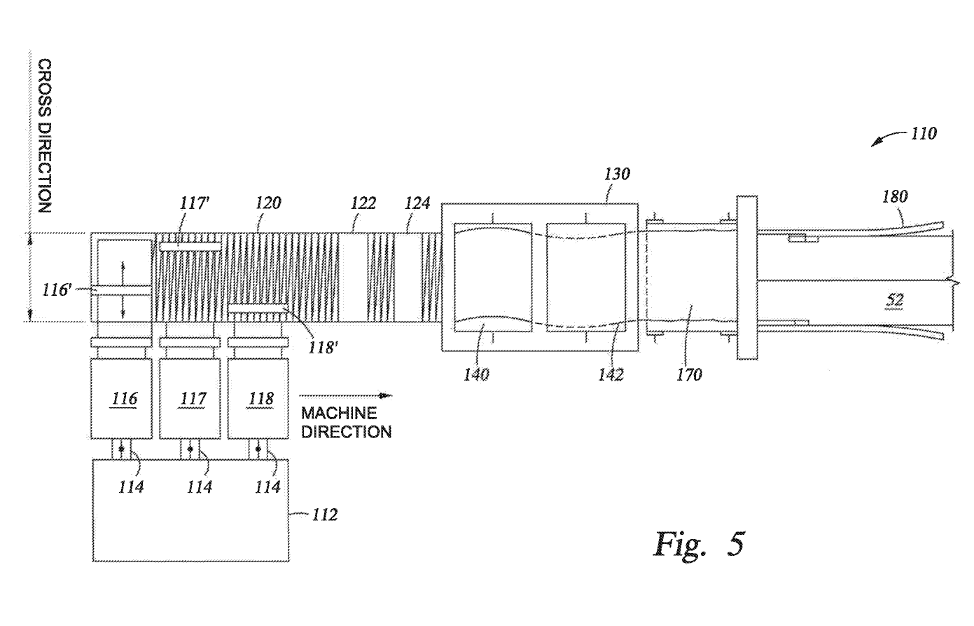

The method 66 will now be described in greater detail. The method 66 commences at 68 with the acquisition of sufficient shoddy material to form the desired energy absorbing layer 52 of the energy absorptive/moisture resistive underlayment 50. It is contemplated that the acquisition of shoddy material at 68 will encompass the acquisition of previously formed nonwoven fiber batts, including carpet underlayments which themselves are typically formed from recycled and/or waste fibers. It is further contemplated that the acquisition of shoddy material at 68 will further encompass the purchase of bales of recycled fibers from another. It is also contemplated that the acquisition of shoddy material at 68 will further encompass the collection of waste fibers and/or nonwoven fibers at a processing line such as processing line 110 of FIG. 5. For example, loose fibers that would otherwise be disposed of as waste materials may be collected at various stations of the processing line 110 such as at cross-lappers 116′, 117′ and/or 118. Additionally, scrap materials are produced at cutting zone 180 where selected portions of the newly formed nonwoven fiber batt are trimmed from the edges of the nonwoven fiber batt.

After acquiring the shoddy material to be used to form the energy absorbing layer 52 of the energy absorptive/moisture resistive underlayment 50 at 68, the method 66 continues with the processing of the acquired shoddy material into recycled fibers at 70. Variously, it is contemplated that processing of the shoddy material into recycled fibers at 70 may include shredding shoddy material acquired in the form of nonwoven fiber batts into loose fibers and/or cleaning loose fibers to remove contaminants therefrom. If the recycled fibers have already been baled, processing of the shoddy material into recycled fibers at 70 shall also encompass the use of a bale breaker to literally break the bale into loose fibers.

The method 66 shall now be further described with respect to FIG. 5. As may now be seen, FIG. 5 is a schematic top plan view of a processing line 110 suitable for constructing the energy absorbing layer 52 of the energy absorptive/moisture resistive underlayment 50. Thus, the processing line performs 72 through 86 of the method 66. At 72 of method 66, a homogeneous blend of the recycled fibers is produced by blending the fibers together in a fiber blender 112. Of course, depending on the homogeneity of the recycled fibers produced at 70 and/or the desired homogeneity of the blend of recycled fibers be formed into the energy absorbing layer 52, blending of the recycled fibers at 72 of method 66 and the corresponding use of the fiber blender 112 may be omitted.

A suitably homogeneous blend of recycled fibers is then transported by conveyor pipes 114 from the fiber blender 112 or other source of recycled fibers to a web forming device, in this example, first, second and third web-forming devices 116, 117 and 118, for formation of a fiber web therefrom. Variously, the recycled fibers transported to the web-forming devices 116, 117 and 118 are natural fibers such as cotton or wool, synthetic fibers such as polyester or polypropylene, a mixture of different types of natural fibers, a mixture of different types of synthetic fibers or a mixture of one or more types of nature fibers and one or more synthetic fibers. As disclosed herein, each of web-forming devices 116, 117 and 118 is a garnett machine. Of course, an air laying machine, known in the trade as a Rando webber, or another suitable type of machine can be employed as the web-forming devices 116, 117 and 118.

The garnett machines 116, 117 and 118 card the homogeneous blend of recycled fibers into a recycled fiber web having a desired width at 74 of the method 66. The recycled fiber web is then transported to a cross lapper, or, as disclosed herein, first, second and third cross-lappers 116′, 117′ and 118′ where the recycled fiber web is cross-lapped onto a slat conveyor 120 moving in the machine direction. The cross-lappers 116′, 117′ and 118′ reciprocate back and forth in the cross direction from one side of the conveyor 120 to the other side such that the thickness of the recycled fiber web increases as the cross-lappers 116′, 117′ and 118′ cause the recycled fiber web to repeatedly overlap itself, thereby layering the recycled fiber web. The number of layers that make up the recycled fiber web is determined by the speed of the conveyor 120 relative to the speed at which successive layers of the web are layered on top of each other and the number of cross-lappers 116′ 117′, and 118′. Thus, the number of layers which make up the recycled fiber web can be increased by slowing the relative speed of the conveyor 120 relative to the speed at which the cross-lappers 116′, 117′ and 118′ layer the recycled fiber web on top of itself, by increasing the number of cross-lappers 116′, 117′ and 118′, or both. Conversely, the number of layers which make up the recycled fiber web can be decreased by increasing the speed of the conveyor 120 relative to the speed of at which the cross-lappers 116′, 117′ and 118 layer the recycled fiber web on top of itself by decreasing the number of cross-lappers 116′, 117′, and 118′, or both. As disclosed herein, it is contemplated that the number of layers in the recycled fiber web may vary based upon the desired characteristics of the energy absorbing layer 52 and/or the energy absorptive/moisture resistive underlayment 50. As a result, the speed of the conveyor 120 relative to the speed at which successive layers of the web are layered on top of one another by the cross-lappers 116′, 117′ and 118′ and the number of cross-lappers 116′, 117′ and 118′ for forming the web may vary accordingly.

Proceeding to 76 of method 66, a heat curable resin is applied to the recycled fiber web by a resin applicator 122. While there are a variety of techniques suitable for applying resins onto the web, most commonly, either a liquid resin is sprayed or a froth resin is extruded onto the recycled fiber web. More specifically, as the recycled fiber web moves along the conveyor 120 in the machine direction, the liquid resin is sprayed onto the recycled fiber web by one or more spray heads (not shown in FIG. 5) that move in a transverse or cross direction to substantially coat the recycled fiber web. Alternatively, the froth resin can be extruded onto the recycled fiber web using a knife or other means. In still another alternative, the recycled fiber web may either be fed through or dipped into a resin bath. The recycled fiber web is then saturated with the applied resin by crushing the resin into the recycled fiber web using nip rollers (not shown in FIG. 5), disposed along the transverse direction of the conveyor 120, which apply pressure to the surface of the recycled fiber web. Finally, in still another alternative, the resin may be crushed into the recycled fiber web by applying vacuum pressure through the recycled fiber web.

It is contemplated that a heat curable resin would be suitable for the purposes disclosed herein. It is further contemplated that any one of a variety of heat curable resins would be suitable. While the heat curable resin would typically be comprised of polyvinyl acetate, the heat curable resin may be a polymeric composition such as vinylidene chloride copolymer, latex, acrylic or other suitable chemical compound. For example, one heat curable resin suitable for the purposes disclosed herein is sold under the name SARAN 506 by the Dow Chemical Company of Midland, Mich. If desired, the resin may contain antimicrobial, antifungal, or hydrophobic additives, all of which would enhance the properties of the energy absorbing layer 52 formed by the method 66.

After saturating the recycled fiber web with resin at 76, the method 66 proceeds to 78 where the conveyer 120 transports the recycled fiber web to a needle loom 124. Using a needle-punching process well known in the art, the needle loom 124 increases the density of the recycled fiber web. More specifically, the needle loom 124 bonds the recycled fibers of the recycled fiber web by mechanically entangling the recycled fibers within the web. To do so, the needle loom 124 includes a needle board containing a plurality of downwardly-facing barbed needles arranged in a non-aligned pattern. The barbs on the needles are positioned such that they capture fibers when the needle is pressed into the web, but do not capture any fibers when the needle is removed from the web. A variety of needles suitable for the purposes disclosed herein are offered by the Foster Needle Company, Incorporated of Manitowoc, Wis. As disclosed herein, use of the needle loom 124 provides mechanical compression of the recycled fiber web prior to the vacuum and/or mechanical compression of the recycled fiber web to be applied within housing 130 in the manner described hereinbelow. It should be fully understood, however, that the needle punching process described herein may be unnecessary if adequate compression of the recycled fiber web can be obtained by the vacuum and/or mechanical compression applied within the housing 130. Similarly, it should be equally understood that, if adequate compression of the recycled fiber web using the needle loom 124, the vacuum and/or mechanical compression applied to the recycled fiber web within the housing 130, may be unnecessary and the housing 130 may be employed solely as an oven or other device which heats the compressed recycled fiber web.

After using the needle loom 124 to needle punch the recycled fiber web at 78, the method 66 proceeds on to 80 and 82 for a generally simultaneous compressing and heating of the recycled fiber web. To do so, the conveyor 120 transports the recycled fiber web to housing 130 where vacuum pressure is applied through perforations (not show first and second counter rotating drums 140 and 142 positioned in a central portion of the housing 130. The first and second counter rotating drums 140 and 142 heat the web to the extent necessary to cure the resin saturating the recycled fiber web. For example, heating the recycled fiber web to a temperature in the range of 225 to 275.degree, F. for three to five minutes is suitable for the purposes disclosed herein. Alternatively, the recycled fiber web may be transported through an oven by substantially parallel perforated or mesh wire aprons that mechanically compress the recycled fiber web and simultaneously cure the resin saturating the recycled fiber web.

As the compressed and heated recycled fiber web exits the housing 130, the method 66 proceeds to 84 where the recycled fiber web is cooled while the pressure applied on the recycled fiber web is maintained by a pair of substantially parallel wire mesh aprons 170, only one of which is visible in FIG. 5. The aprons 170 are mounted for parallel movement relative to each other to facilitate adjustment of the recycled fiber web to a wide range of web thicknesses. Variously, the recycled fiber web can be cooled slowly through exposure to ambient temperature air or, in the alternative, ambient temperature air can be forced through the perforations of one apron 170, the recycled fiber web and the perforations of the other apron 170, thereby cooling the recycled fiber web. By continuing to compress the recycled fiber web during the cooling process, the recycled fiber web becomes set in its compressed state. The recycled fiber web is maintained in its compressed state upon cooling since the solidification of the resin bonds the fibers together in that state. After being set in its compressed state, the recycled fiber web may now be characterized as a recycled fiber batt.

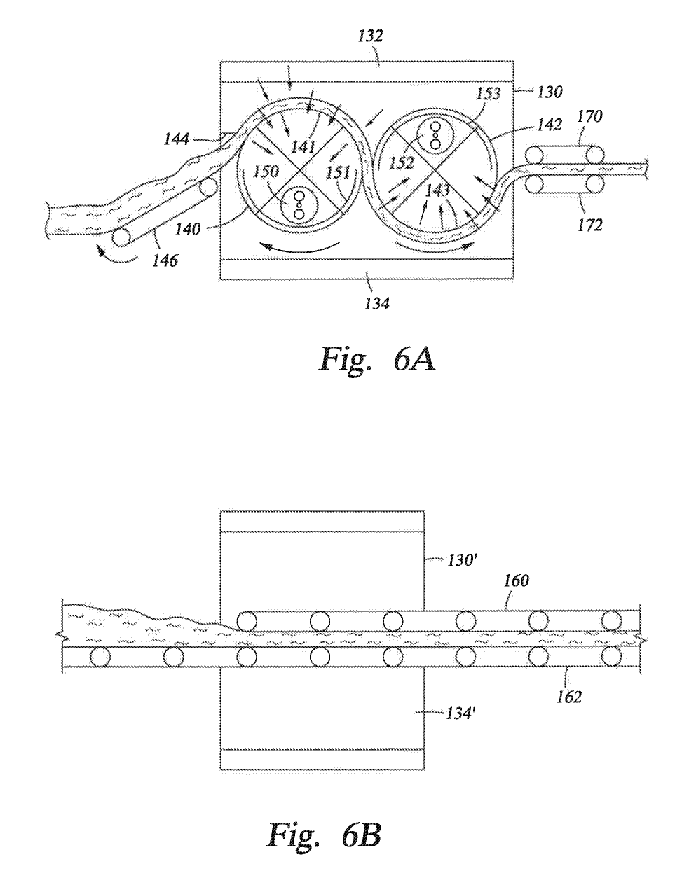

It is contemplated that a variety of resin bonding techniques are suitable for the purposes disclosed herein. One such technique may be seen by reference to FIG. 6A. Here, the recycled fiber web is compressed by vacuum pressure generated using the counter-rotating drums 140, 142. As may now be seen, positioned in a central portion of the housing 130 are counter-rotating drums 140, 142 having perforations 141, 143, respectively. Additionally, an air circulation chamber 132 is positioned in an upper portion of the housing 130 while a furnace 134 is positioned in a lower portion thereof. The drum 140 is positioned adjacent an inlet 144 though which the recycled fiber web is fed by an infeed apron 146. A suction fan 150 is positioned in communication with the interior of the drum 140. The lower portion of the circumference of the drum 140 is shielded by a baffle 151 positioned inside the drum 140 such that the suction-creating air flow is forced to enter the drum 140 through the perforations 141, which are proximate the upper portion of the drum 140, as the drum 140 rotates.

The drum 142 is downstream from the drum 140 in the housing 130. The drums 140, 142 can be mounted for lateral sliding movement relative to one another to facilitate adjustment for a wide range of web thicknesses (not shown). The drum 142 includes a suction fan 152 that is positioned in communication with the interior of the drum 142. The upper portion of the circumference of the drum 142 is shielded by a baffle 153 positioned inside the drum 142 so that the suction-creating air flow is forced to enter the drum 142 through the perforations 143, which are proximate the lower portion of drum 142, as the drum 142 rotates. The recycled fiber web fed into the housing 130 by the infeed apron 146 is held in vacuum pressure as it moves from the upper portion of the rotating drum 140 to the lower portion of the counter rotating drum 142. The furnace 134 heats the air in the housing 130 as it flows from the perforations 141, 143 to the interior of the drums 140, 142, respectively, to cure the resin in the web to the extent necessary to bind together the fibers in the web.

Referring to FIG. 6B, in an alternative resin bonding process, the recycled fiber web is fed into the housing 130′ where a pair of substantially parallel perforated or mesh wire aprons 160, 162 compress the recycled fiber web to the desired extent. As the compressed recycled fiber web is transported through the housing 130′, an oven 134′ heats the compressed recycled fiber web to cure the resin to the extent necessary to bind the fibers in the web together.

Collectively referring next to FIGS. 4, 5, 6A and 6B, the method 66 continues to 84 where a pair of substantially parallel first and second perforated or wire mesh aprons 170 and 172 maintain the recycled fiber web in the compressed state while the recycled fiber web is cooled to solidify the bonds formed between the fibers by the resin. Preferably, the aprons 170 and 172 are mounted for parallel movement relative to each other to facilitate adjustment for a wide range of web thicknesses (not shown). The web can be cooled slowly through exposure to ambient temperature air or, in the alternative, ambient temperature air can be forced through the perforations of one apron, through the web and through the perforations of the other apron to cool the web and set it in its compressed state. The web is maintained in its compressed form upon cooling since the resin bonds the fibers together in the compressed state.

The method 66 proceeds on to 86 where the recycled fiber web (which, after being set in the compressed state by the cooling process, shall now be referred to as a recycled fiber batt) is transported to cutting zone 180 where the lateral edges of the recycled fiber batt are trimmed to a desired width. The recycled fiber batt is then cut transversely to a desired length.

In an alternate embodiment it is contemplated that thermal bonding may be used to bond the recycled fiber batt together in lieu of the resin bonding method described herein. Thermal bonding uses low-melt binder fibers to bind the fibers together. Low-melt binding fibers do not actually melt as the term is generally understood. Instead, the low-melt binder fibers become sticky or tacky when heated to a certain temperature. If the recycled fiber batt is to be thermally bonded, the low-melt binder fibers are blended with the recycled fibers to make a homogeneous fiber blend of recycled fibers and low-melt binder fibers. The fiber blend is then carded into a recycled fiber web as described above. It is not necessary to apply a resin to the recycled fiber web if the web is to be thermally bonded, although, in many instances it may be desirable to do so to obtain the advantageous features of the resin set forth herein. The recycled fiber web is then needle punched, if a compression is desired prior to the generally simultaneous heating and compression thereof. The recycled fiber web is then sent to a compression and heating apparatus, such as those illustrated in FIGS. 6A and 6B, where the heat melts the low melt binder fibers. The recycled fiber web is then cooled to complete formation of the recycled fiber batt and subsequently trimmed to desired dimensions, again in the same manner previously set forth with the resin-bonded embodiment of the disclosed recycled fiber batt.

In the thermal bonded embodiment, the recycled fiber batt is preferably formed from a homogeneous blend of binder fibers and recycled fibers. The binder fibers can be either natural or synthetic fibers. The binder fibers may also be mono-component binder fibers or bi-component binder fibers. While the homogeneous mixture of recycled fibers and binder fibers can be any of a number of suitable fiber blends, for purposes of illustrating the process and the blend, the mixture is comprised of binder finders in an amount sufficient for binding the fibers of the blend together upon application of heat at the appropriate temperature to melt the binder fibers. In one example, the binder fibers are in the range of about 5 percent to about 95 percent by total volume of the blend. Preferably, the binder finders are present in the range of about 10 percent to about 15 percent for a high-loft batt and in the range of about 15 percent to about 40 percent for a densified batt, as those characteristics are discussed below. The recycled fibers in the remaining blend volume ranges anywhere from about 5 percent to about 95 percent. Preferably, the recycled fibers are present in the range of about 85 percent to about 90 percent for a high-loft batt and in the range of about 60 percent to about 85 percent for a densified batt, as those characteristics are discussed below. Of course, the foregoing blends are provided by way of example and it is fully contemplated that other blends of binder fibers and recycled fibers are suitable for use when forming a recycled fiber batt in accordance with the techniques disclosed herein.

The weight per unit length of the binder fibers is also a consideration. While coarse binder fibers, e.g. those binder fibers having a weight per unit length of at least about 5 denier, are suitable for the purposes described herein, preferably the binder fibers are fine binder fibers. It is believed that a recycled fiber batt made of fine binder fibers has a lower porosity due to the ability of the fine binder fibers to fill smaller void spaces within the recycled fiber batt. By filling more of the void spaces than coarse binder fibers, the use of fine binder fibers results in a recycled fiber batt characterized by better acoustical properties relative to a recycled fiber batt formed using coarse binder fibers. In various embodiments, it is contemplated that the weight per unit length of the fine binder fibers to be used in forming the recycled fiber batt shall be no greater than about 5 denier, no greater than about 3 denier or no greater than about 1 denier.

It is further contemplated that, in lieu of the resin or thermal bonding techniques disclosed herein, various mechanical bonding techniques may be used to bond the recycled fibers of the recycled fiber batt together. Broadly speaking, mechanical bonding is the process of bonding the fibers of a nonwoven fiber web together without the use of resins, adhesives, or heat. Examples of mechanical bonding techniques include, among others, needle punching, hydro entanglement and clustering. As previously set forth, needle punching is a technique using barbed needles to entangle fibers with one another. Hydro entanglement is a process using streams of high pressure water to entangle the fibers of the nonwoven web. Clustering is the mechanical entanglement of fibers during the batt forming process. Clustering frequently uses crimped fibers or fibers that otherwise have a complex shape. It is also contemplated that the fiber batt may be manufactured using different combinations of resin bonding, mechanical bonding, and/or thermal bonding.

The use of resin in the batt is advantageous for many reasons. First, resin-bonded batts are less porous than mechanically bonded or thermally bonded batts. More specifically, the resin is able to permeate through the batt more thoroughly and effectively than fibers, such as recycled fibers or binder fibers, due to its liquid form. The decreased porosity makes the fiber batt less water permeable, gives the batt better acoustical insulating properties, and makes it easier to attach various items, such as the moisture barrier or a floor covering, to the surface of the batt. In fact, depending on the specific level of water and/or vapor permeability sought, it is possible to eliminate the need for the moisture barrier by applying a sufficient amount of resin to the fiber batt.

In the embodiment utilizing a nonwoven fiber batt as the energy absorbing layer 52, the basis weight, density, and thickness of the underlayment are determined by, among other factors, the process of compressing the batt as it is cooled. The ratio of batt density to batt thickness generally dictates whether the underlayment is a high loft batt or a densified batt. For purposes herein, a densified energy absorbing layer has a ratio of basis weight (in ounces) per square foot to thickness inches) greater than approximately 2 to 1. Thus, a densified underlayment would have a density greater than approximately 1.5 pounds per cubic foot (pcf). Conversely, an underlayment having a ratio of basis weight to thickness of less than approximately 2 to 1 and a density less than 1.5 pcf is defined herein as high loft.

The expected amount of handling prior to installation should be a consideration when selecting the density of the fiber batt. Denser fiber batts provide better acoustical properties than less dense fiber batts. The acoustical properties of the fiber bat are important because a person of ordinary skill in the art will generally want the fiber batt to attenuate as much sound as possible. However, denser fiber batts are also less flexible than less dense fiber batts. Flexibility is important because a preferred feature of the fiber batt is the ability to be rolled up for storage, transportation, handling, and installation. Thus, when selecting the density of the fiber batt, a person of ordinary skill in the art must balance the need for acoustical performance with the need for flexibility. In various embodiments, a suitable balance for the density of the fiber batt is between about 1 pcf and about 10 pcf, between about 2 pcf and about 7 pcf, or between about 3 pcf and about 5 pcf.

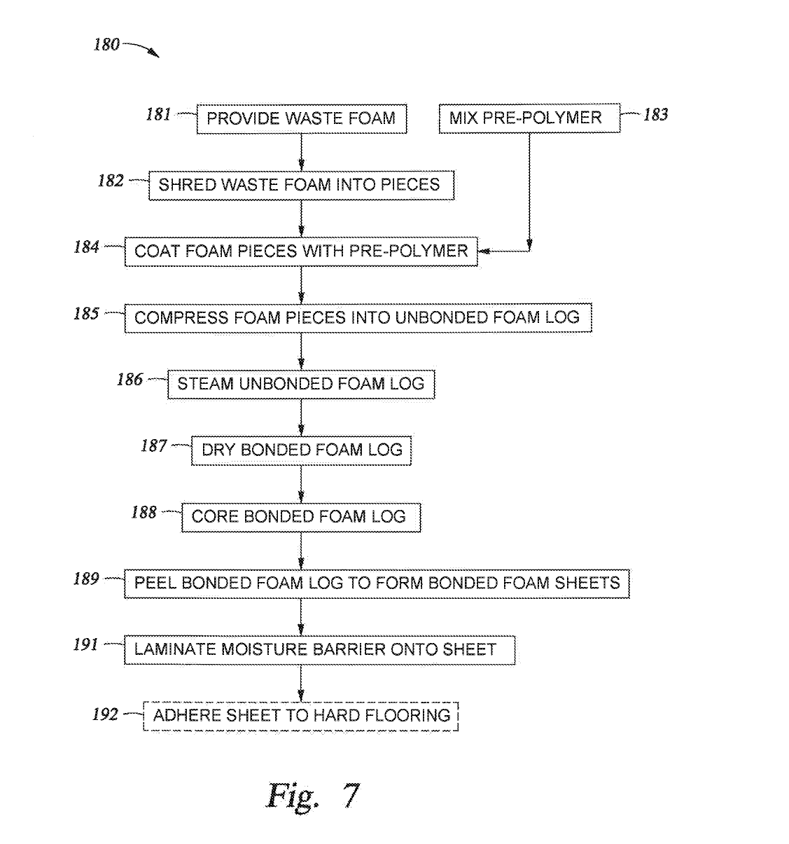

Referring now to FIG. 7, a second method 180 for manufacturing an energy absorptive/moisture resistive underlayment will now be described in greater detail. As disclosed herein, the method 180 is used to form either the energy absorptive/moisture resistive underlayment 50-1 or the energy absorptive/moisture resistive underlayment 50-2 whenever the material to be recycled when forming the energy absorptive/moisture-resistive underlayment 50-1, 50-2 is waste foam, for example, foam that was previously used in a product to be disposed of or scrap foam produced during the manufacture of a foam product such as the excess foam trimmed from a newly formed foam product so that it has a desired size and/or shape. As will be more fully described below, the method 180 recycles waste foam while forming an energy absorptive/moisture resistive underlayment by providing waste foam at 181, shredding the waste foam into foam pieces at 182, separately mixing a pre-polymer at 183, coating the foam pieces with the pre-polymer at 184, compressing the foam pieces into an unbonded foam log at 185, steaming the unbonded foam log at 186, thereby curing the pre-polymer such that bonds are made between the pieces of foam, thereby forming a bonded foam log from the unbonded foam log, drying the bonded foam log at 187, coring the bonded foam log at 188, peeling sheets of bonded foam from the bonded foam log at 189 and laminating at least one moisture barrier onto the sheets of bonded foam at 191. If desired, the sheets of bonded foam may then be adhered or otherwise attached to the hard flooring at 192.

The method 180 for manufacturing an energy absorptive/moisture resistive underlayment formed using recycled foam begins with a supply of waste foam, most commonly, variously sized pieces of scrap prime foam produced by a prime foam manufacturer while trimming components formed using foam to a desired shape or size. It is fully contemplated, however, that both new and used foam are equally suitable for the purposes disclosed herein. Importantly, the size and shape of the foam to be recycled for use in the energy absorptive/moisture resistive underlayment is unimportant as the provided foam is shredded into smaller foam pieces prior to formation of a foam log therewith. Variously, the provided foam to be recycled for subsequent use in an energy absorptive/moisture resistive underlayment may be polyurethane, latex, polyvinyl chloride (PVC), or any other polymeric foam of any density. It is fully contemplated, however, that the energy absorptive/moisture resistive underlayment may instead be formed using a variety of foam compositions other than those specifically recited herein and the identification of certain foams as suitable for the purposes disclosed herein should not be characterized in a limiting manner.

The provided foam is typically generally free of moisture but may contain an incidental amount of impurities, such as felt, fabric, fibers, leather, hair, metal, wood, plastic or the like. Preferably, the provided foam is polyurethane foam with a density similar to the desired density of the subsequently produced recycled energy absorptive/moisture resistive underlayment. If desired, the foam may be sorted by type and/or density prior to shredding such that foam pieces of similar composition and density are used to make a single foam log. Using foam of similar composition and density to make a single foam log produces a more uniform density throughout the foam log, and thus throughout the subsequently produced underlayment.

Once the waste foam to be used to form a bonded foam log has been provided at 181, the method 180 proceeds to 182 where the waste foam is placed in a shredding machine for shredding into smaller foam pieces. Broadly speaking, a shredding machine is a device provided with a plurality of rotating or otherwise moving blades capable of cutting foam placed thereinto into smaller pieces. The amount of time that the waste foam spends in the shredding machine determines the size of the shredded pieces of foam provided thereby. Some shredding machines are configured to operate in a batch mode in which a load of unshredded foam is deposited into a holding tank where it is cut into small pieces of foam by the blades. The shredded foam is then removed from the holding tank and another load of unshredded foam is deposited thereinto. Other shredding machines are configured to operate in a continuous mode in which a flow of unshredded foam is continuously fed into the shredding machine, for example, using a conveyer or other type of transport system for shredding. As additional unshredded foam is fed into the shredding machine, a roughly equal amount of shredded foam is removed from the shredding machine by the conveyer or other transport system. A shredding machine suitable for the purposes disclosed herein is the foam shredder manufactured by the Ormont Corporation of Paramus, N.J.

It is contemplated that the foam pieces produced by the shredding machine may have a specific type of geometric shape such as a spherical or cubical shape. Most commonly, however, the shredding process performed by the shredding machine will produce foam pieces that are irregularly shaped and that tend to vary in shape from piece to piece. Generally, the shape of the smaller foam pieces produced by the shredding machine is unimportant because the foam pieces produced thereby will tend to conform to the shape of the mold later used to form bonded foam logs. Broadly speaking, however, the smaller foam pieces should be sized such that they are large enough to be easily handled yet small enough such that there is not an abundance of empty space between the foam pieces when used to fill a mold. Preferably, the smaller foam pieces should be sized such that they all range from about ¼-inch to about ¾-inch in length, width and height.

As disclosed herein, the method 180 includes two discrete processes—the shredding of waste foam into foam pieces at 182 and the mixing of a pre-polymer solution at 183—which are performed generally simultaneous with one another. In the embodiment disclosed herein, it is contemplated that the primary components of the pre-polymer solution mixed at 183 are an isocyanate, a polyol and an oil. As will be more fully described below, the isocyanate reacts with the polyol at 183 and with moisture in the steam at 186 to bond the pieces of foam together. The oil lowers the overall viscosity of the pre-polymer solution to facilitate better mixing and distribution of the components of the pre-polymer mixture. The lowered viscosity of the pre-polymer solution also allows the pre-polymer solution to uniformly coat the foam pieces so that improved bonding occurs. In the embodiment disclosed herein, it is contemplated that the pre-polymer solution will contain generally equal amounts (by weight) of the isocyanate, the polyol and the oil. Thus, if the pre-polymer solution includes about 30 percent (by weight) of the isocyanate, it would also include about 30 percent (by weight) of the polyol and about 30 percent (by weight) of the oil.

It is contemplated that a variety of isocyanates, such as toluene diisocyanate (TDI), diisocyanatodiphenyl methane (MDI) or blends thereof, may be used when forming the pre-polymer solution. For example, suitable isocyanates would include, among others, m-phenylene diisocyanate, p-phenylene diisocyanate, polymethylene polyphenyl isocyanate, 2,4-toluene diisocyanate, 2,6-toluene diisocyanate, 4,4-diisocyanatodiphenyl methane, dianisidine diisocyanate, bitolylene diisocyanate, naphthalene-1,4-diisocyanate, diphenylene-4,4′-diisocyanate, xylylene-1,4-diisocyanate, xylylene-1,2-diisocyanate, xylylene-1,3-diisocyanate, bis(4-isocyanatophenyl)-methane, bis(3-methyl-4-isocyanatophenyl)-ethane, isophorone diisocyanate, 4,4-diphenylpropane diisocyanate, hexamethylene diisocyanate, methylene-bis-cyclohexylisocyanate, and mixtures thereof. Of course, it is fully contemplated that isocyanates other than those specifically recited herein are also suitable for the purposes disclosed herein and that the formulation of the pre-polymer solution should not be limited to the particular isocyanates disclosed herein. The preferred isocyanates are RUBINATE® 9041 MDI, available from the Huntsman Corporation of Salt Lake City, Utah, or POLYMERIC MDI 199, available from the Dow Chemical Corporation of Midland, Mich. The isocyanate comprises between about 10 percent (by weight) and about 90 percent (by weight) of the pre-polymer solution; preferably between about 20 percent (by weight) and about 50 percent (by weight) of the pre-polymer solution; and most preferably between about 25 percent (by weight) and about 40 percent (by weight) of the pre-polymer solution.

It is further contemplated that a variety of polyols, such as diol, triol, tetrol, polyol or blends thereof, may be used when forming the pre-polymer solution. For examples, suitable polyols would include, among others, ethylene glycol, propylene glycol, butylene glycol, hexanediol, octanediol, neopentyl glycol, 1,4-bishydroxymethyl cyclohexane, 2-methyl-1,3-propane diol, glycerin, trimethylolethane, hexanetriol, butanetriol, quinol, polyester, methyl glucoside, triethyleneglycol, tetraethylene glycol, polyethylene glycol, dipropylene glycol, polypropylene glycol, diethylene glycol, glycerol, pentaerythritol, trimethylolpropane, sorbitol, mannitol, dibutylene glycol, polybutylene glycol, alkylene glycol, oxyalkylene glycol, ethylene glycol, diethylene glycol, dipropylene glycol, triethylene glycol, tripropylene glycol, tetraethylene glycol, tetrapropylene glycol, trimethylene glycol, tetramethylene glycol, 1,4-cyclohexanedimethanol (1,4-bis-hydroxymethylcyclohexane) and mixtures thereof. Of course, it is fully contemplated that polyols other than those specifically recited herein are also suitable for the purposes disclosed herein and that the formulation of the pre-polymer solution should not be limited to the particular polyols disclosed herein. The preferred polyol is VORANOL® 3512A, available from the Dow Chemical Corporation of Midland, Mich. The polyol comprises between about 10 percent (by weight) and about 90 percent (by weight) of the pre-polymer solution; preferably between about 20 percent (by weight) and about 50 percent (by weight) of the pre-polymer solution; and most preferably, between about 25 percent (by weight) and about 40 percent (by weight) of the pre-polymer solution.

It is still further contemplated that a variety of oil may be used when forming the pre-polymer solution. The oil may be any aromatic or non-aromatic, natural or synthetic oil. For example, suitable oils would include, among others, naphthenic oil, soybean oil, vegetable oil, almond oil, castor oil, mineral oil, oiticica oil, anthracene oil, pine oil, synthetic oil, and mixtures thereof. Of course, it is fully contemplated that oils other than those specifically recited herein are also suitable for the purposes disclosed herein and that the formulation of the pre-polymer solution should not be limited to the particular oils disclosed herein. The preferred oil is VIPLEX® 222, available from the Crowley Chemical Company of New York, N.Y. The oil comprises between about 10 percent (by weight) and about 90 percent (by weight) of the pre-polymer solution; preferably between about 20 percent (by weight) and about 50 percent (by weight) of the pre-polymer solution; most preferably, between about 25 percent (by weight) and about 40 percent (by weight) of the pre-polymer solution.

In addition to the foregoing components, it is further contemplated that the pre-polymer solution may also contain any number of other additives which improve the characteristics of the bonded foam. For example, the pre-polymer solution may contain a flame retardant chemical compound, such as melamine, expandable graphite or dibromoneopentyl glycol, which improves the flame retardant properties of the bonded foam. The pre-polymer solution may also contain an antimicrobial additive, such as zinc pyrithione, which improves the antimicrobial properties of the bonded foam, as discussed in the aforementioned patent application. The pre-polymer solution may also contain an antioxidant, such as butylated hydroxy toluene, which improves the resistance of the bonded foam to oxidative-type reactions, such as scorch resulting from high exothermic temperatures. Finally, the pre-polymer solution may also contain colored dye, such as blue, green, yellow, orange, red, purple, brown, black, white, or gray dye, to distinguish certain bonded foam products from other bonded foam products. Of course, it is fully contemplated that the pre-polymer solution may contain still other additives other than those specifically recited herein and that the formulation of the pre-polymer solution should not be limited to the particular additives disclosed herein.

The selected components are combined at 183, typically, using a mixer, to form a pre-polymer solution having the desired composition. It is contemplated that the mixer may be either a dynamic mixer or a static mixer. It is further contemplated that the mixer may be either a batch mixer or a continuous process mixer. Preferably, the mixer is a tank containing a motorized paddle-type mixing blade. Of course, it is fully contemplated that various types of mixers other than those specifically recited herein are also suitable for the disclosed purposes disclosed and that the mixer used to blend the selected components into the pre-polymer solution should not be limited to the particular types of mixers disclosed herein. Variously, it is contemplated that the components of the pre-polymer solution may be combined all at once, or they may be added one at a time to the pre-polymer solution as it is being mixed. Preferably, mixing of the pre-polymer solution continues until there are about 10 percent free isocyanates available for reacting with the steam during the steaming process. The mixed pre-polymer solution has a viscosity between about 100 and 1,000 centipoises, preferably between about 400 and 600 centipoises, at a temperature between about 100.degree. F. and about 110.degree. F. Although the time varies depending on the composition of the pre-polymer solution, it is contemplated that the components of the pre-polymer solution are mixed together for at least about 1 hour prior to application of the pre-polymer solution to the foam pieces. Preferably, the isocyanate, the polyol, and the oil are mixed together for at least about 4 hours and, at the end of the 4 hours, an amine catalyst is added to the pre-polymer solution and mixed for at least about an additional two hours.

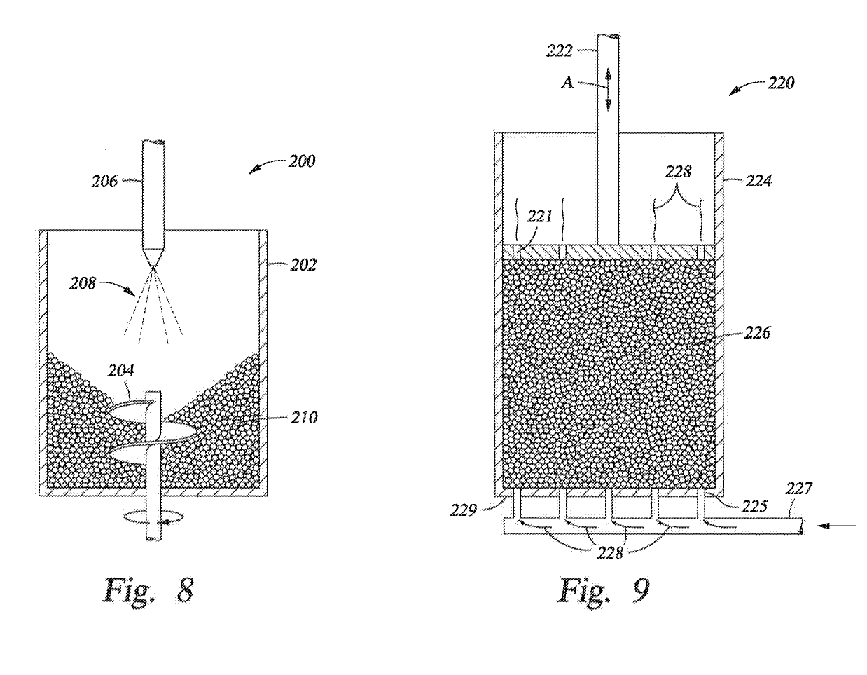

After the components of the pre-polymer solution (isocyanate, polyol, oil and any additives) have been mixed together for a suitable period of time at 182, the method 180 proceeds to 184 where the pre-polymer solution is coated onto the foam pieces. Variously, it is contemplated that the coating machine may either be a batch-type coating machine or a continuous-type coating machine. A batch-type coating machine 200 suitable for the purposes disclosed herein is illustrated in FIG. 8. As may now be seen, the coating machine is comprised of a tank 202, an agitator 204, and a pre-polymer solution applicator 206. The size and shape of the tank 202 may be varied to suit the particular application. Similarly, the number and type of agitators 204 may be varied to suit the particular application. In this regard, it should be clearly understood that, for ease of illustration, a single agitator 204 is shown in FIG. 8.

The process of coating a selected amount of foam pieces 210 begins by depositing the foam pieces 210 inside the tank 202. The pre-polymer solution applicator 206 then sprays pre-polymer solution 208 onto the foam pieces 210. While the pre-polymer applicator 206 is spraying the foam pieces 210 with the pre-polymer solution 208, the agitator 204 rotates with respect to the tank 202, thereby circulating the foam pieces 210 within the tank 202. As the foam pieces 210 are circulated within the tank 202, the foam pieces 210 are substantially coated with the pre-polymer solution 208. The time required to substantially coat the foam pieces 210 with the pre-polymer solution 208 varies depending on the volume and density of the foam pieces 210, the size of the tank 202, the number and type of agitators 204 and the rate at which the pre polymer solution 208 is sprayed onto the foam pieces 210. Generally, however, it is contemplated that the coating process will require between about 0.5 minutes and about 15 minutes to substantially coat the foam pieces 210 with the pre-polymer solution 208. Preferably, the coating process should require between about 1 minute and about 10 minutes to substantially coat the foam pieces 210 with the pre-polymer solution 208. Most preferably, the coating process should require between about 1.5 minutes and about 2.5 minutes to substantially coat the foam pieces 210 with the pre-polymer solution 208. Although, in the coating process disclosed herein, the pre-polymer solution 208 is sprayed onto the foam pieces 210, it is contemplated that the foam pieces 210 may be substantially coated with the pre-polymer solution 208 using a variety of other techniques such as dipping or roller coating. Accordingly, it is fully contemplated that techniques other than those specifically recited herein may be used to substantially coat the foam pieces 210 with the pre-polymer solution 208 and that the coating process should not be limited to the particular processes disclosed herein.

Referring next to FIG. 9, after the foam pieces have been coated with the pre-polymer, the method 180 proceeds to 185 where the coated foam pieces are transported to a mold 220 for compression thereof. The mold 220 comprises a base 229, a cylindrical wall 224, a reciprocating piston 222, and a steam injection system 227. A drive system (not shown) coupled to the piston 222 enables the piston to be driven in either direction along axis A. By driving the piston 222 along the axis A, the volume of the cavity defined by the cylindrical wall 224, and the base 229 can be selectively increased or decreased. In addition to being configured for movement along the axis A, the piston 222 is further configured for selective removal from the cavity and positioning away from the remainder of the mold 220 to facilitate easy loading of coated foam pieces into the cavity. Typically, the foam pieces are weighed before being loaded into the mold 220. After the foam pieces are loaded into the mold 220, the piston 222 compresses the coated foam pieces to form a foam log 226. The compression ensures complete contact between the coated foam pieces forming the foam log 226. As the weight of the coated foam pieces is known and the volume of the cavity into which the coated foam pieces are compressed may be readily determined based upon the extent to which the piston 222 penetrates the cavity, the density of the foam log 226 can be controlled by compressing the foam log 226 to a specific volume. For example, if the coated foam pieces weigh 100 pounds and the desired density of the foam log is 4 lbs/ft.sup.3, then the piston 222 is driven in direction A until the volume of the interior cavity defined by the base 229, the cylindrical sidewalls 224 and the piston 222 is reduced to 25 cubic feet.

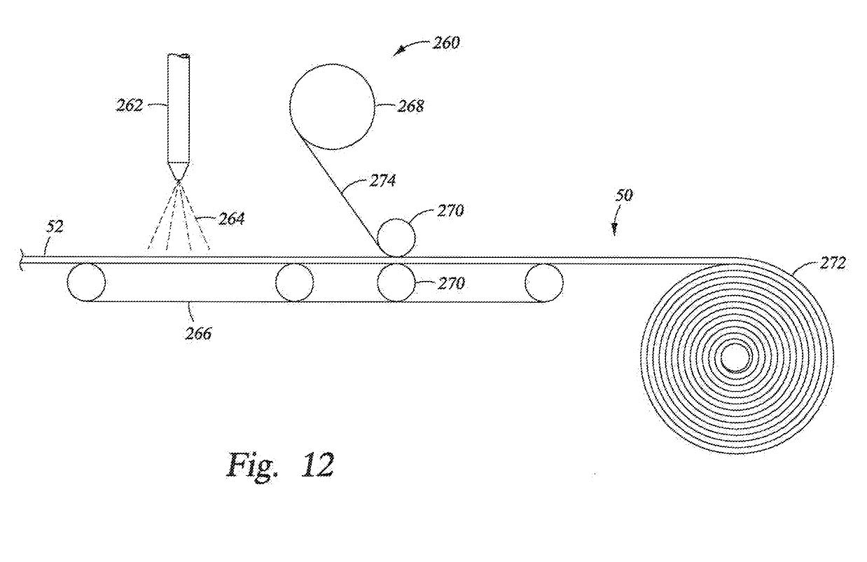

The mold 220 illustrated in FIG. 9 employs a batch-type compression. It is fully contemplated, however, that the coated foam pieces may be compressed into a foam log using a variety of other techniques. For example, FIG. 11 illustrates an extruder suitable for forming a foam log using a continuous compression technique. Thus, it is fully contemplated that compression techniques other than those specifically recited herein may be used to compress the coated foam pieces 210 into the foam log 226. Accordingly, the compression technique employed as part of the method 180 should not be limited to the particular processes disclosed herein.

After the foam pieces 210 are compressed into the foam log 226, the method 180 proceeds to 186 where the foam log 226 is steamed to the pre-polymer. To do so, a steam supply (not shown) provides a flow of steam 228 to the steam injection system 229. The steam 228 is forced, through apertures 225 in the base 229, into the cavity holding the newly formed foam log 226. The steam 228 passes through the foam log 226 and exits through apertures 221 in the piston 222. As the steam passes through the foam log 226, the moisture in the steam cures the pre-polymer, thereby establishing bonds between the foam pieces 210 forming the foam log 226. After passing through the foam log 226, any excess steam exits through perforations in the piston 222. After being formed, the bonded foam log 226 is removed from the mold 220. For example, the mold 220 may be configured such that the wall 224 is removable, thereby facilitating easy removal of the foam log 226 after the steaming process is complete. Alternately, the foam log 226 may be removed after the piston 222 has been removed from the cavity and repositioned in the manner hereinabove described. It is fully contemplated that steaming processes other than those specifically recited herein may be used to cure the foam log 226. Accordingly, the steaming process employed as part of the method 180 should not be limited to the particular process disclosed herein.

The steam 8 may be any heated steam that is at least about 212.degree. F. and a sufficient pressure to permeate the foam log 226. Preferably, the temperature of the steam is between about 220.degree. F. and about the combustion temperature of the foam (about 1400.degree, F.). The pressure of the steam is preferably between about 10 pounds per square inch gauge (psi) and about 100 psi. Most preferably, the temperature of the steam is between about 246.degree. F. and about 256.degree. F. and the pressure of the steam is between about 13 psi and 15 psi for a batch operation and between about 30 psi and about 45 psi for a continuous operation. The steaming time is dependent on the steam pressure and the density of the foam log. For a 4 pcf foam log and using the most preferred steam, the steam time is between about 0.5 minutes and about 3 minutes, preferably about 1.0 minutes and about 1.5 minutes. For an 8 pcf foam log, the steam time is between about 1.5 minutes and about 5 minutes, preferably about 2 minutes and about 3 minutes. Steam times for foam logs of other densities can be interpolated or extrapolated from these steam times and steam data.

After the foam log 226 has been cured and removed from the mold 220, the method 180 proceeds to 187 where the bonded foam log 226 is allowed to dry. The time required to dry the bonded foam log 226 varies based upon the density of the bonded foam log 226 and the amount of moisture present in the bonded foam log 226. A lower density foam log may be sufficiently dry to allow immediate processing. However, to ensure that the bonded foam log 226 is sufficiently dry such that moisture in the foam log 226 will not affect any of the equipment used to process the foam log 226, the bonded foam log 226 is typically set aside to dry for a period between of 12 and to 24 hours at ambient temperature and humidity. If desired, drying of the bonded foam log 226 may be sped up by forcing ambient, heated, and/or dried air over or through the bonded foam log 226. It is fully contemplated that drying processes other than those specifically recited herein may be used to dry the bonded foam log 226. Accordingly, the drying process employed as part of the method 180 should not be limited to the particular process disclosed herein.

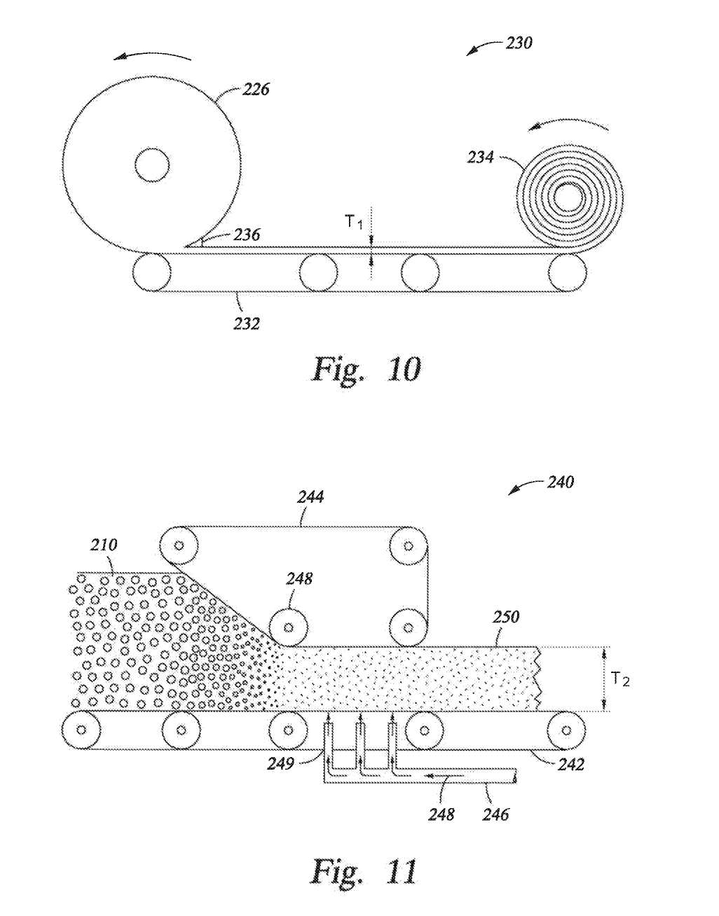

After drying is complete, the method 180 proceeds to 188 for coring of the bonded foam log 226. To core the bonded foam log 226, an aperture is drilled through a center axis thereof. A rod is then inserted into the aperture, thereby enabling the bonded foam log 226 to be handled without damaging the foam. After coring the log at 188, the method 180 then proceeds to 189 where a peeling machine peels the bonded foam log 226. A peeling machine 230 suitable to peel the bonded foam log 226 may be seen by reference to FIG. 10. As may now be seen, the peeling machine 230 includes a blade 236, a conveyor 232, and a take-up roll 234. The bonded foam log 226 is rotated against the blade 236 such that the blade 236 peels off a sheet of bonded foam having a uniform thickness, T.sub.1. As previously set forth, the sheet of bonded foam is employed as a recycled flooring underlayment for a hard flooring system. As the bonded foam is peeled off of the bonded foam log 226, the bonded foam log 226 is continuously lowered with respect to the blade 236 such that the sheet of bonded foam peeled off of the bonded foam log 226 by the blade 236 maintains the desired thickness T.sub.1 of foam. In other words, as the diameter of the bonded foam log 226 is reduced, the bonded foam log 226 is lowered so that a uniform thickness of sheet of bonded foam is continuously peeled off of the foam log 226. If desired, a trim station (not shown) positioned along the conveyor system 232 may be employed to trim the bonded sheet of foam to a uniform width. The sheet of bonded foam, which is now suitable for use as part of a flooring underlayment, is transported by conveyor system 232 and is collected on the take-up roll 234 for delivery to distributors, wholesalers, retailers and/or other consumers of the underlayment. If desired, the conveyor system may be stopped periodically and the continuous sheet of underlayment may be cut lengthwise and the take-up roll 234 replaced with a new take-up roll so that the rolls of flooring underlayment 238 are lighter and easier to handle.

Rather than employing the described batch-type process to form the bonded foam log 226, it is contemplated that the method 180 may instead be configured to employ a continuous-type processing technique to form the bonded foam log 226. FIG. 11 illustrates an extruder 240 suitable for continuously compressing and steaming the foam pieces 210 into a generally continuous bonded foam log 250. The continuous extruder 240 comprises an upper conveyor 244, a lower conveyor 242 and a steam injection system 246. The process of compressing and steaming a bonded foam log commences with the placement of foam pieces 210 onto the lower conveyor 242. Because the density of the foam log 250 produced by the continuous extruder 240 depends on the mass flow rate of the foam pieces 210 through the continuous extruder 240 as well as the volumetric flow rate of the foam log 250 exiting the extruder, the foam pieces 210 are deposited onto the lower conveyor 242 at a specified weight per unit time. As the foam pieces 210 travel through the continuous extruder 240, the foam pieces 210 are compressed by the upper conveyor 244. Because the upper conveyor 244 and the lower conveyor 242 travel in the same direction and the foam pieces 210 are continuously entering the continuous extruder 240, the foam pieces 210 are compressed by the downward traveling upper conveyor 244. The height of the upper conveyor 244 over the lower conveyor 242 is adjustable and the density of the foam 250 produced thereby can be adjusted by raising and lowering the upper conveyor 242 relative to the lower conveyor 244.

When the pieces 210 have been compressed into a foam log 250 having a desired density, steam injection system 246 injects a flow of steam 248 into the foam log 250 through perforations 249 in the lower conveyor 242. The steam passes through the foam log and any excess steam exits by passing through perforations (not shown) in the upper conveyor 244. The continuous extruder 240 is configured such that the residence time of the foam log 250 in the steaming area of the continuous extruder 240 is generally equal to the steaming time required in the batch process previously described herein. The bonded foam log produced by the continuous extruder 240 is generally rectangular in cross section and, as a result, is sliced into sheets of flooring underlayment rather than being peeled in the manner described hereinabove.

After either a nonwoven fiber batt formed of shoddy material is formed at 86 or a sheet of bonded foam is formed at 189 (both of which are, as previously set forth, suitable for use as the recycled energy absorbing layer 52), the moisture barrier 54 is laminated onto the recycled energy absorbing layer 52 at either 90 of method 66 or at 191 of method 180 to produce the recycled energy absorptive/moisture resistive underlayment 50.

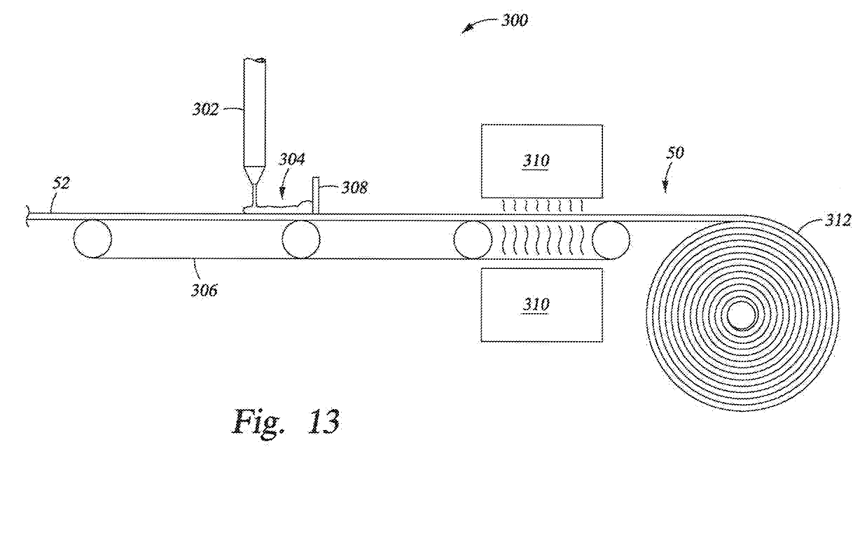

For the embodiment in which the moisture barrier 54 is a film, FIG. 12 illustrates an apparatus 260 for laminating a moisture impermeable film onto the recycled energy absorbing layer 52 in accordance with 90 of method 66 or 191 of method 180. A conveyer 266 transports the recycled energy absorbing layer 52 to an adhesive applicator 262. The adhesive applicator 262 sprays an adhesive 264 onto the recycled energy absorbing layer 52 positioned therebelow. Alternatively, the adhesive applicator 262 could extrude a frothed adhesive onto the recycled energy absorbing layer 52. A moisture resistant film 274 from roll 268 is then layered onto a first side surface of the recycled energy absorbing layer 52. Two nip rollers 270 compresses the moisture resistant film 274 and the recycled energy absorbing layer 52 together to form the recycled energy absorptive/moisture resistive underlayment 50 having a moisture barrier 54 on one side of the recycled energy absorbing layer 52. If the adhesive 264 needs to be cured, the recycled energy absorptive/moisture resistive underlayment 50 can pass through an oven (not shown) to cure the adhesive. The recycled energy absorptive/moisture resistive underlayment 50 is then collected on roller 272 and shipped to wholesalers, distributors and/or retailers as needed.

For the embodiment in which the moisture barrier 54 is a closed cell foam, FIG. 13 illustrates an apparatus 300 for laminating a layer of closed cell foam 304 onto the recycled energy absorbing layer 52. As may now be seen, a conveyor 306 transports the recycled energy absorbing layer 52 to a foam applicator 302 which deposits foam 304 onto the recycled energy absorbing layer 52 positioned therebelow. Alternatively, the foam 304 may be sprayed, roller coated, or otherwise applied to the recycled energy absorbing layer 52. In still another alternative, the recycled energy absorbing layer 52 may be dipped into a vat of the foam 304. A doctor blade 308 regulates the amount of foam 304 deposited on top of the recycled energy absorbing layer 52. The foam 304 and recycled energy absorbing layer 52 are then transported through an oven 310 that cures the foam 304. The resulting recycled energy absorptive/moisture resistive underlayment 50 having a moisture barrier 54 formed on one side thereof is then collected on a roller 312 and shipped to wholesalers, distributors, and/or retailers as needed.

If the recycled energy absorbing layer is 52 is a nonwoven fiber batt formed using shoddy fibers, the moisture barrier 54 may be produced by calendering one or more surfaces of the nonwoven fiber batt. Calendering is a process by which one surface of a nonwoven fiber batt is modified by passing the batt between a set of cylindrical drums, one of which is heated. Alternatively, the batt can be placed on a smooth conveyor belt and passed through an oven. The heat from the cylindrical drums or oven melts the synthetic fibers in the nonwoven fiber batt such that they form a thin layer of material similar to a moisture impermeable film. The calendered surface of the nonwoven fiber batt differs from a layer of moisture impermeable film laminated onto a surface of the nonwoven fiber batt in that the nonwoven fiber batt and the calendered surface are formed from the same material, generally polymeric material, but in fiber and sheet form, respectively. The calendered surface of the nonwoven fiber ban is generally moisture impervious but, depending on the specific temperature and calendering apparatus used, may be vapor permeable. Because the calendered surface of the nonwoven fiber batt is moisture impervious, the calendered surface of the nonwoven fiber batt acts as a moisture barrier, thereby eliminating the need for another type of moisture barrier. Thus, calendering the surface of the nonwoven fiber batt is advantageous because it eliminates the need to laminate a moisture barrier thereonto.

In an additional alternative embodiment, the recycled energy absorbing layer 52 and/or the moisture barrier 54 can contain a scented or deodorizing additive. Scented and deodorizing additives are advantageous because they improve the smell of the flooring and can mask or eliminate unwanted odors. Scented and deodorizing additives are well known in the art, as evidenced by scented and deodorizing carpet cleaner. It is fully contemplated that a scented or deodorizing additive may be included: (a) in the recycled fiber blend used to form the recycled energy absorbing layer 52 comprised of a nonwoven fiber batt formed from shoddy fibers; (b) within the pre-polymer used to form the recycled energy absorbing layer 52 comprised of a foam pad formed from bonded foam; or (c) within the moisture barrier 54 itself. Alternatively, the scented or deodorizing additive can be attached to the recycled energy absorbing layer 52, the moisture barrier 54, or both.

It is contemplated that methods other than the disclosed adhesive techniques may be used to laminate the moisture barrier 54 onto the energy absorbing layer 52. For example, some moisture barriers 54 become tacky when heated. If such a moisture barrier 54 were used, the moisture barrier 54 would be layered onto the energy absorbing layer 52 without the use of an adhesive. The energy absorbing layer 52 and moisture barrier 54 would then be heated to make the moisture barrier 54 tacky such that the moisture barrier 54 bonds to the energy absorbing layer 52. When the underlayment 50 cools, the moisture barrier 54 would then be attached to the energy absorbing layer 52 without the use of a separate adhesive. Alternatively, if the moisture barrier 54 and the energy absorbing layer 52 contain polymeric and/or thermoplastic materials, the moisture barrier 54 and the energy absorbing layer 52 can be integrally joined by heating the moisture barrier 54 and the energy absorbing layer 52, contacting or compressing the moisture barrier 54 and the energy absorbing layer 52 together, and then cooling the moisture barrier 54 and the energy absorbing layer 52. It is contemplated that any other bonding method that does not use an adhesive may also be used to laminate the moisture barrier 54 onto the energy absorbing layer 52 to form the recycled energy absorptive/moisture resistive underlayment 50.

If it is desired that the recycled energy absorptive/moisture resistive underlayment 50 be attached to the hard flooring 60 at 92 of method 66 or at 192 of method 180, the recycled energy absorptive/moisture resistive underlayment 50 is preferably attached to the hard flooring layer 60 after the moisture barrier 54 has been attached to the recycled energy absorbing layer 52. The process of adhering the recycled energy absorptive/moisture resistive underlayment 50 onto the hard flooring 60 is similar to the process of adhering the moisture barrier 54 onto the recycled energy absorbing layer 52. More specifically, an adhesive is sprayed onto a side surface of the hard flooring 60 and the recycled energy absorptive/moisture resistive underlayment 50 is subsequently laminated onto an underside of the hard flooring 60. A pair of nip rollers ensure that the recycled energy absorptive/moisture resistive underlayment 50 completely contacts the hard flooring 60. As part of the process of attaching the recycled energy absorptive/moisture resistive underlayment 50 to the hard flooring 60, the hard flooring 60 can be inverted so the side that faces up during the manufacturing process will be the underside of the hard flooring 60 when the hard flooring layer 60 is installed. By doing so, the force of gravity shall be able to hold the recycled energy absorptive/moisture resistive underlayment 50 on the hard flooring 60 until the adhesive takes full effect and bonds the two together.

Another consideration for the recycled energy absorptive/moisture resistive underlayment 50 is the thickness of the recycled energy absorbing layer 52. While thicker recycled energy absorbing layers 52 are preferred in some applications, for example, soft flooring applications such as carpet underlayment, thinner recycled energy absorbing layers 52 are preferred for use in conjunction with hard flooring. An example of a recycled energy absorbing layer 52 forming a component of a recycled energy absorptive/moisture resistive underlayment 50 suitable for use with hard flooring would have a thickness of between about 0.05 inches and about 0.25 inches, a density of between about 2 pcf and about 20 pcf, and a basis weight of between about 0.5 ounces per square foot and about 10 ounces per square foot. Preferably, the recycled energy absorbing layer 52 has a thickness between about 0.1 inches and about 0.3 inches, a density between about 5 pcf and about 10 pcf, and a basis weight between about 1 ounce per square foot and about 4 ounces per square foot. A recycled energy absorptive/moisture resistive underlayment formed in accordance with foregoing would typically come in a 3 foot by 60 foot roll and have a roll weight of about 28 pounds.

There are many advantages to using the recycled energy absorptive/moisture resistive underlayment 50 over existing underlayments. The recycled energy absorptive/moisture resistive underlayment 50 contains recycled fibers or bonded foam, either of which would tend to lower the cost of manufacturing the recycled energy absorptive/moisture resistive underlayment 50 whenever the cost of recycling those components of the recycled energy absorptive/moisture resistive underlayment 50 is less than the cost of using new components, for example, prime foam, in the recycled energy absorptive/moisture resistive underlayment 50. With lowered manufacturing costs, the manufacturer can sell the recycled energy absorptive/moisture resistive underlayment 50 to the consumer at a lower cost. The recycled materials in the underlayment 50 are also appealing to consumers who prefer recycled materials for environmental reasons. The recycled energy absorptive/moisture resistive underlayment 50 can also be attached to a bottom side surface of hard flooring 60 so that the time and complexity of installing the hard flooring system 49 comprised of the recycled energy absorptive/moisture resistive underlayment 50 and the hard flooring 60 is reduced substantially. The recycled energy absorptive/moisture resistive underlayment 50 also acts a moisture barrier, absorbs the sound generated by a person walking on the recycled energy absorptive/moisture resistive underlayment 50 and smoothes irregularities in the subfloor 62 on which the hard flooring system 49 is installed.

While a number of preferred embodiments of recycled energy absorptive/moisture resistive underlayments and associated hard flooring systems have been shown and described herein, modifications thereof may be made by one skilled in the art without departing from the spirit and scope of the disclosed teachings. Accordingly, the embodiments described herein are provided purely by way of example and are not intended to be limiting. Many variations, combinations, and modifications of the teachings disclosed herein are possible and are contemplated as being fully within the scope of the teachings set forth herein. Accordingly, the scope of protection is not limited by the description set out above, but is defined by the scope of the claims which follow, that scope including all equivalents of the subject matter thereof.

What is claimed is:

1. A method for applying hard flooring underlayment to a floor, the underlayment having an energy absorbing layer and a moisture barrier laminated to a side surface of the energy absorbing layer, the method comprising the steps of:
determining the type of floor;
orienting the moisture barrier based on the type of floor; and
applying the underlayment to the floor.

2. The method of claim 1 wherein determining the type of floor comprises determining that the floor is an upper floor, a slab foundation floor, or a basement floor; and wherein the moisture barrier is oriented as the top surface of the underlayment for upper floors and the moisture barrier is oriented as the bottom surface of the underlayment for either basement floors or slab foundation floors.

3. The method of claim 1 wherein the energy absorbing layer comprises rebond foam.

4. The method of claim 2 wherein the underlayment further comprises a second moisture barrier laminated on the side surface of the energy absorbing layer opposite the first moisture barrier.

5. The method of claim 3 wherein the underlayment further comprises a second moisture barrier laminated on the side surface of the energy absorbing layer opposite the first moisture barrier.

6. The method of claim 3 wherein the rebond foam comprises recycled foam bits and binder, and the binder comprises an antimicrobial additive.

7. The method of claim 1 wherein:
the energy absorbing layer has a plurality of edge surfaces;
the moisture barrier has at least one edge surface laying flush with a corresponding one of the plurality of edge surfaces of the energy absorbing layer and at least one edge surface projecting past a corresponding one of the plurality of edge surfaces of the energy absorbing layer, forming a flap; and
applying the underlayment to the floor further comprises applying a plurality of sections of underlayment so that the energy absorbing layers abut one another to form a seam and the moisture barriers overlap at the seam.

8. The method of claim 7 wherein applying a plurality of sections of underlayment further comprises:
laying a first section of underlayment onto the floor; and
laying a second section of underlayment onto the floor so that the energy absorbing layer of the second section abuts the energy absorbing layer of the first section;
wherein the second section overlaps the projecting moisture barrier flap of the first section of underlayment.

9. The method of claim 8 wherein the projecting moisture barrier flap of the second section of underlayment extends up a wall.

10. The method of claim 7 wherein the plurality of sections of underlayment are applied in overlapping fashion so that the projecting flap of the moisture barrier of all but one section overlaps one of the edges of another of the plurality of sections of underlayment in which the energy absorbing layer and the moisture barrier lay flush; and wherein the projecting flap of the moisture barrier of the one section extends up a wall.

11. The method of claim 10 further comprising:
applying an additional strip of moisture barrier material to the base of a wall adjacent an edge of one of the plurality of sections of underlayment in which the energy absorbing layer and the moisture barrier lay flush; and
applying a baseboard to conceal the moisture barrier extending up the wall;
wherein the additional strip of moisture barrier extends from underneath the section of underlayment adjacent the wall up along the wall to a height greater than that of the underlayment.

12. A method for applying hard flooring underlayment to a floor, the underlayment having an energy absorbing layer and a moisture barrier laminated to a side surface of the energy absorbing layer, the method comprising the steps of:
applying underlayment onto a floor; wherein:
the energy absorbing layer has a plurality of edge surfaces;
the moisture barrier has at least one edge surface laying flush with a corresponding one of the plurality of edge surfaces of the energy absorbing layer and at least one edge surface projecting past a corresponding one of the plurality of edge surfaces of the energy absorbing layer, forming a flap;
applying the underlayment to the floor further comprises applying a plurality of sections of underlayment so that the energy absorbing layers abut one another to form a seam and the moisture barriers overlap at the seam; and
the moisture barrier flap of one of the plurality of sections of underlayment extends up a wall.

13. The method of claim 12 wherein the plurality of sections of underlayment are applied in overlapping fashion so that the projecting flap of the moisture barrier of all but one section overlaps one of the edges of another of the plurality of sections of underlayment in which the energy absorbing layer and the moisture barrier lay flush; and wherein the projecting flap of the moisture barrier of the one section extends up a wall; the method further comprising applying an additional strip of moisture barrier material to the base of another wall adjacent an edge of one of the plurality of sections of underlayment in which the energy absorbing layer and the moisture barrier lay flush; and applying a baseboard to conceal the moisture barrier extending up the wall; wherein the additional strip of moisture barrier extends from underneath the section of underlayment adjacent the wall up along the wall to a height above the underlayment.

14. The method of claim 12 wherein applying a plurality of sections of underlayment further comprises:
laying a first section of underlayment on the floor so that the energy absorbing layer of the edge surface of the underlayment having the moisture barrier flap is adjacent to the wall and the moisture barrier flap extends up the wall;
laying one or more subsequent sections on the floor so that the energy absorbing layers abut one another to form seams and the moisture barriers overlap at the seams;
applying one or more strips of additional moisture barrier material along the base of another wall adjacent an edge of one of the plurality of sections of underlayment in which the energy absorbing layer and the moisture barrier lay flush; and
attaching baseboard material to the base of the walls to conceal the moisture barrier material.

15. The method of claim 12 further comprising determining that the floor is an upper floor, a slab foundation floor, or a basement floor; and orienting the moisture barrier based on the type of floor; and wherein the moisture barrier is oriented as the top surface of the underlayment for upper floors and the moisture barrier is oriented as the bottom surface of the underlayment for either basement floors or slab foundation floors.

16. The method of claim 12 wherein the underlayment also comprises a second moisture barrier located on the side surface of the energy absorbing layer opposite the first moisture barrier, and wherein all edges of the second moisture barrier are flush with the edges of the energy absorbing layer.

17. The method of claim 14 wherein the underlayment also comprises a second moisture barrier located on the side surface of the energy absorbing layer opposite the first moisture barrier, and wherein all edges of the second moisture barrier are flush with the edges of the energy absorbing layer.

18. The method of claim 12 wherein the moisture barrier is located on the bottom surface of the energy absorbing layer.

19. The method of claim 12 wherein the moisture barrier is located on the top surface of the energy absorbing layer.

20. The method of claim 12 wherein:
the energy absorbing layer comprises rebond foam;
the seams are taped; and
the projecting flap of moisture barrier for each section of underlayment extends approximately 4 inches beyond the edge of the energy absorbing layer.
